(19) United States
(12) Patent Application Publication
(10) Pub. No.: US 2006/0026629 A1
(43) Pub. Date: Feb. 2, 2006

(54) Method for advertising via IP video telephone

(76) Inventors: John C. Harris, Rockwall, TX (US); Brad Stacy Shirley, Plano, TX (US); Guenter Hanfried Lehmann, Sachse, TX (US); Rene M. Cardenas, Dallas, TX (US); Michael R. Wilkinson, Richardson, TX (US); H. Michael Willey, Garland, TX (US); Jason A. Lickliter, Frisco, TX (US); CC Fichtner, Dallas, TX (US)

Correspondence Address: HOWISON & ARNOTT, L.L.P, P.O. BOX 741715, DALLAS, TX, 75374-1715, US

(21) Appl. No.: 11/194,049

(22) Filed: Jul. 29, 2005

Related U.S. Application Data
(60) Provisional application No. 11/184,033, filed on Jul. 30, 2004.
(60) Provisional application No. 11/184,034, filed on Aug. 3, 2004.
(60) Provisional application No. 60/599,617, filed on Aug. 6, 2004.
(60) Provisional application No. 60/599,727, filed on Aug. 6, 2004.
(60) Provisional application No. 60/600,034, filed on Aug. 9, 2004.
(60) Provisional application No. 60/600,408, filed on Aug. 10, 2004.
(60) Provisional application No. 60/600,745, filed on Aug. 11, 2004.
(60) Provisional application No. 60/600,910, filed on Aug. 12, 2004.
(60) Provisional application No. 60/605,019, filed on Aug. 27, 2004.
(60) Provisional application No. 60/600,865, filed on Aug. 12, 2004.
(60) Provisional application No. 60/641,684, filed on Jan. 5, 2005.
(60) Provisional application No. 60/641,883, filed on Jan. 5, 2005.
(60) Provisional application No. 60/641,326, filed on Jan. 4, 2005.
(60) Provisional application No. 60/641,328, filed on Jan. 4, 2005.

(51) Int. Cl. H04N 7/10; H04N 7/025; H04Q 7/38; H04Q 7/20

(52) U.S. Cl. 725/32; 725/34; 725/35; 455/424; 455/414.1

(57) ABSTRACT

A method for providing advertising to a video telephone is disclosed, including the steps of monitoring the usage of the video telephone to detect a number of user activities. The detected user activities are stored within a database. The stored user activities within the database are used to generate directed content that is transmitted to the video telephone.

### RELATED INVENTIONS

This application claims priority from U.S. Provisional Application No. 60/592,847 filed Jul. 30, 2004 entitled “A/V COMMUNICATION NETWORK,” which is incorporated herein by reference; U.S. Provisional Application No. 60/598,504 filed Aug. 3, 2004 entitled “METHOD OF PROVIDING A/V TELECOMMUNICATIONS TO CONSUMERS,” which is incorporated herein by reference; U.S. Provisional Application No. 60/599,617 filed Aug. 6, 2004 entitled “DEMOGRAPHIC ADVERTISEMENT ON AN A/V TELECOMMUNICATIONS SYSTEM,” which is incorporated herein by reference; U.S. Provisional Application No. 60/599,727 filed Aug. 6, 2004 entitled “METHOD OF PROVIDING ADVERTISING TO AN A/V TELECOMMUNICATION DEVICE,” which is incorporated herein by reference; U.S. Provisional Application No. 60/600,034 filed Aug. 9, 2004 entitled “METHOD OF COLLECTING DEMOGRAPHIC DATA FROM AN A/V TELECOMMUNICATION DEVICE,” which is incorporated herein by reference; U.S. Provisional Application No. 60/600,408 filed Aug. 10, 2004 entitled “METHOD OF DELIVERING SYNCHRONIZED CONTENT TO AN A/V TELECOMMUNICATION DEVICE,” which is incorporated herein by reference; U.S. Provisional Application No. 60/600,745 filed Aug. 11, 2004 entitled “INTEGRATED INTERACTIVE ADVERTISING PROMOTIONS AND AN A/V TELECOMMUNICATION DEVICE,” which is incorporated herein by reference; U.S. Provisional Application No. 60/600,910 filed Aug. 12, 2004 entitled “METHOD OF ADVERTISING IN A VIDEO ANSWERING MESSAGE ON AN A/V TELECOMMUNICATION DEVICE,” which is incorporated herein by reference; U.S. Provisional Application No. 60/605,019 filed Aug. 27, 2004 entitled “BRAND ASSOCIATIVE ICON BASED DIALING PROTOCOL AND SYSTEM,” which is incorporated herein by reference; U.S. Provisional Application No. 60/600,865 filed Aug. 12, 2004 entitled “INTEGRATED INTERACTIVE ADVERTISING PROMOTIONS AND A/V TELECOMMUNICATIONS DEVICE,” which is incorporated herein by reference; U.S. Provisional Application No. 60/641,684 filed Jan. 5, 2005 entitled “INNER PROCESSOR COMMUNICATION IN A MULTIPROCESSOR DEVICE,” which is incorporated herein by reference; U.S. Provisional Application No. 60/641,883 filed Jan. 5, 2005 entitled “INNER PROCESSOR COMMUNICATION IN A VOICE OVER IP VIDEO TELEPHONY DEVICE,” which is incorporated herein by reference; U.S. Provisional Application No. 60/641,326 filed Jan. 4, 2005 entitled “METHOD FOR SYNCHRONIZATION OF AUDIO AND VIDEO PACKETS WITHIN AN IP VIDEO TELEPHONE,” which is incorporated herein by reference; and U.S. Provisional Application No. 60/641,328 filed Jan. 4, 2005 entitled “IP VIDEO TELEPHONE WITH POTS TELEPHONE CONNECTIVITY,” which is incorporated herein by reference.

### TECHNICAL FIELD OF THE INVENTION

The present invention relates to video telephony, and more particularly, to a directed advertising via an IP video telephone.

### BACKGROUND OF THE INVENTION

The combination of video and audio channels provides a unique platform for interpersonal communication. With the availability of broadband Internet network connections in the home, there is an opportunity to further methods of interaction between content providers and consumers.

An IP telephone is a telephone device that transmits voice over a network using data packets instead of circuit switch connections over voice only networks. An IP telephone refers to the transfer of voice over the Internet protocol (IP) of the TCP/IP protocol suite. Other voice over packet (VOP) standards exist for frame relay and ATM networks but many people use the terms voice over IP (VOIP) or IP telephone to mean voice over any packet network

IP telephones originally existed in the form of client software running on multi-media PCs for low cost PC to PC communications over the Internet. Quality of service (QOS) problems associated with the Internet and the PC platform itself resulted in poor voice quality due to excessive delay, variable delay, and network congestion resulting in lost packets, thus relegating VOIP primarily to hobby status. The QOS provided by the Internet continues to improve as the infrastructure is augmented with faster backbone links and switches to avoid congestion, higher access connections to the end users such as XDSL cut-down latency, and new protocols like RSVP and techniques like tag switching give priority to delay sensitive data such as voice and video. IP telephones include one wire systems for transmitting both voice and data. The data may comprise video data of the user of the IP phone in some embodiments. IP telephones provide better scalability as additional stations are added to the system, and the ability to mix and match IP telephones from different manufacturers.

IP telephones have several advantages over multimedia PCs with client software including lower latencies due to an embedded system implementation, a familiar user paradigm of using a telephone versus a PC enabled phone, greater reliability, and lower station costs where a PC is not required.

When considering IP telephones for home use, the network interface that is available is typically a DSL or cable broadband connection. Typically, IP telephones connect to a cable modem or DSL modem via a high speed interface such as Ethernet or universal serial bus (USB). There are also emerging home communication standards such as being presented by home RF, which provides wireless communication within the home. In this new residential environment, IP telephones will attach to the home LAN and have access to the data network and the PSTN via either a DSL or cable modem which communicates to DSLAM or cable system equipment.

A home voice over IP telephone including video capabilities would provide a platform for providing a number of different services and opportunities to the home user. A platform for implementing this service would be greatly desirable.

### SUMMARY OF THE INVENTION

The present invention disclosed and claimed herein, in one aspect thereof, comprises a method for advertising to a video telephone. The usage of the video telephone is monitored to detect a number of user activities occurring on the video telephone. The monitored user activities are stored within a database. Directed content is generated from the user activities stored within the database. The generated directed content is transmitted to the video telephone.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 2 illustrates a handset for a household broadband information appliance;

FIG. 3 illustrates a block diagram of a household broadband information appliance;

FIG. 4 illustrates a block diagram of an IP video telephone;

FIG. 5 is a functional block diagram of the gateway of the IP video telephone;

FIG. 6 is a functional block diagram of the voice over IP processor of the IP video telephone;

FIG. 7 is a functional block diagram of the video processor of the IP video telephone;

FIGS. 8a-8c indicate the various manners in which processing components of the IP video telephone may be interconnected via an Ethernet network;

FIGS. 9a and 9b illustrate analog telephone connections to the IP video telephone;

FIG. 10 is an illustration of a call connection process using the IP video telephone;

FIG. 11 illustrates the manner in which delay may be created between video and audio packets when transmitted over an IP network;

FIG. 12 is a flow diagram illustrating one method for synchronizing audio and video packets;

FIG. 13 illustrates the method of inserting delays into the transmission of packets to achieve synchronization at a receiving end of audio and video packets;

FIG. 14 is an illustration of a home display displayed on the video screen of the IP video telephone;

FIG. 15 is an illustration of the calendar display on the display of the IP video telephone;

FIG. 16 is an illustration of the telephone display on the display of the IP video telephone;

FIG. 17 illustrates other display screens of the IP video telephone;

FIG. 18 illustrates inter unit communications between device processors;

FIG. 19 illustrates the software modules enabling communicating between a pair of IP video telephones;

FIG. 20 illustrates the manner that a stun module interacts with an IP video telephone;

FIG. 21 is a flow diagram illustrating a call connection using the software of FIG. 20;

FIG. 22 is a flow diagram illustrating a call receipt process;

FIG. 23 is a flow diagram illustrating a method for providing an audio/visual network;

FIG. 24 illustrates a network for providing directed user content;

FIG. 25 illustrates a method for providing directed user content;

FIG. 26 illustrates a manner for generating directed user content for a plurality of IP video phones;

FIG. 27 illustrates the provision of various user inputs to a database;

FIG. 28 illustrates a method of interactive data collection;

FIG. 29 illustrates a method of determining user preferences;

FIG. 30 illustrates an IP video phone with integrated incentive promotion manager;

FIG. 31 illustrates a process for providing incentives via an incentive promotion manager;

FIG. 32 illustrates a system for providing advertising with audio/visual message recording;

FIG. 33 illustrates a method for audio/visual message recording including advertising;

FIG. 34 illustrates a recording including advertising;

FIG. 35 illustrates a method of associating advertising with message retrieval;

FIG. 36 illustrates a user interface with branded buttons;

FIG. 37 illustrates programmable branded buttons;

FIG. 38 illustrates a method for using branded buttons;

FIG. 39 illustrates a system for providing synchronous promotional content broadcasts;

FIG. 40 illustrates a method for providing coordinated synchronous content;

FIG. 41 illustrates an IP video telephone having an integrated incentive promotion function; and

FIG. 42 is a flow diagram of an integrated interactive promotion.

### DETAILED DESCRIPTION OF THE INVENTION

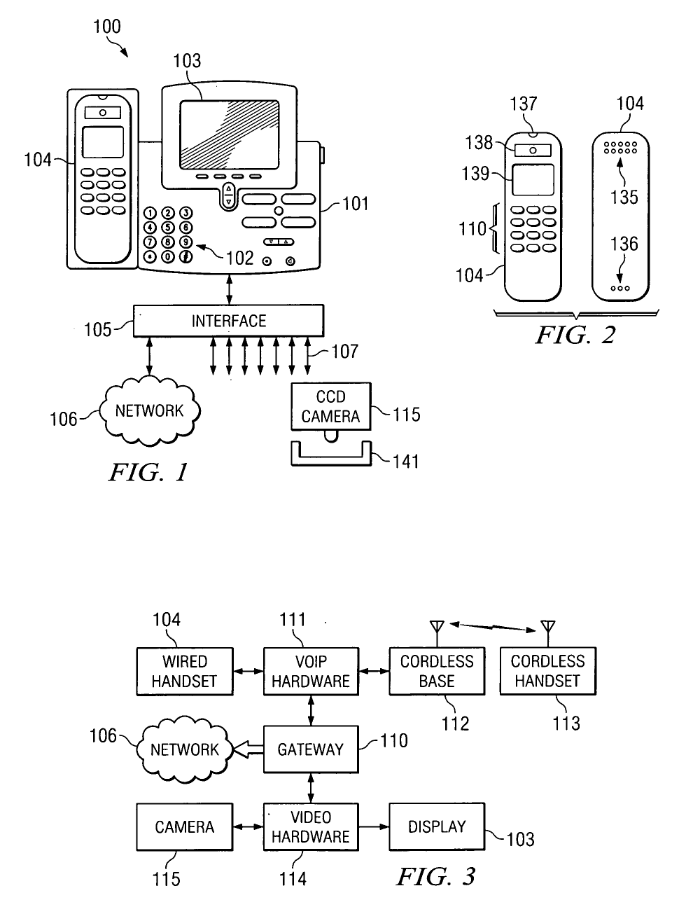

Referring now to the drawings, and more particularly to FIG. 1, there is illustrated a functional depiction of a broadband information appliance 100. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103. In a preferred embodiment, the broadband information appliance 100 comprises a video telephone. The video telephone provides the user with the ability to converse with an individual also having a video telephone while providing both audio and video outputs to each user of a video telephone.

The display of the IP video telephone 402 and the browser operating within the video processor 111 are typically left in a powered state to enable content to be received by the IP video telephone 402 at any point. In this manner, when the IP video telephone is not presently operating with supporting an audio/visual telephone call, the browser may be used to display content to an individual on the screen of the IP video telephone. This enables a host server interconnected with the IP video telephone 402 through a network such as the Internet to consistently provide advertising or other types of directed information on the display of the IP video telephone through the browser. This information may be determined in such a manner that the displayed information is of particular interest to the individual.

Base unit 101 may include manual inputs 102. Typically the manual inputs 102 for a video telephone include a standard telephone keypad with ten numeric buttons plus a “#” and “*” buttons. Manual inputs may further include any number of other button switches, thumb wheels, pointing devices or other appropriate manual input devices. A wide variety of functions and features may be controlled using the manual inputs 102. Manual inputs 102 may include navigation keys or a joy stick for up, down, right and left selections and programmable soft keys. Power and status LEDs may also be provided to display information to a user.

A base unit 102 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver, a wireless connection to the base unit 101 including (or connected to) a wireless transceiver. The wireless transceivers may be a 2.4 GHz transceiver or any other suitable wireless transceiver frequency. The wireless transceivers may be spread spectrum transceivers. A handset 104 wirelessly connected to the base unit may be called a wireless handset.

Base unit 101 is connected to an interface 105. Typically, interface 105 is integral with base unit 101. Interface 105 includes an interface for connection to a network 106 such as an IP network. The network 106 may comprise an open network such as the Internet. Interface 105 includes interface connections 101 for connecting the base unit 101 to a variety of peripherals or networks. Typically, the interface 105 will provide Ethernet ports, telephone handset and keypad support, video capture and display ports including NTSC composite input and output ports, S video ports, NTSC camera ports and LCD display ports. The interface 105 may include audio capture and reproduction ports, an external microphone port, an external speaker port, two audio line level inputs, and a hands-free speaker phone.

A digital video camera 115 is connected to the base unit 101. Typical digital video camera 115 comprises a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

Referring now to FIG. 2, a more detailed description of the components that may be incorporated into the handset 104 is illustrated. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or scan image data. An LCD display 139 may be provided on the handset 104 to allow the user to see the input from the digital video camera 137, or show video data being displayed on display 103 when the handset 104 is being used remotely from the base unit 101. The handset display 135 may also show alternate visual data. The handset 104 may further include manual inputs 140 to control the video camera 137, hand display 139 and scanner 138.

Referring now to FIG. 3, there is illustrated an overall functional block diagram of a basic broadband information appliance 100. A gateway 110 provides an interface to a network 106. In a preferred embodiment, the network is an IP network such as the Internet. The gateway 110 communicates with voice over Internet protocol (VOIP) hardware 111 and video hardware 114. The voice over IP hardware 111 provides all of the voice and audio functionalities for the broadband information appliance 100. The video hardware 114 provides the video capabilities to the broadband information appliance 100 such as streaming video of a speaker or display of a browser for browsing the IP network such as the Internet. The voice over IP hardware 111 may be directly connected to a wired handset 104 or may be connected to a cordless base unit 112 which provides wireless communications with a cordless handset 113. The video hardware 114 may be connected to a video camera 115 and a display 103.

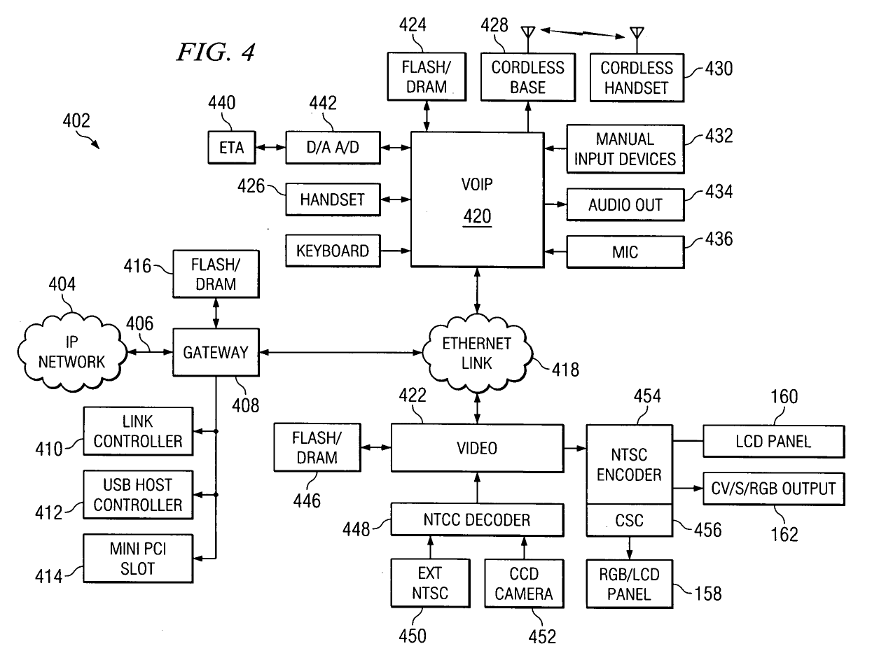

Referring now to FIG. 4, there is illustrated a detailed functional block diagram of an IP video telephone 402 that may more particularly comprise the broadband information appliance discussed above. The IP video telephone 402 is connected to an IP based network 404 through a connection 406. The interconnection 406 may be a wired connection such as a DSL connection or a cable connection through a DSL or cable modem, respectively. Alternatively, the interconnection 406 between the IP network 404 and the IP video phone 402 may comprise a wireless or satellite connection. The IP network 404 in the preferred embodiment comprises the Internet. However, any packet based network would be applicable to the following description. The IP video telephone 402 has its interface to the outside world and the IP network at a gateway processor 408. The gateway processor 408 provides communication with one or more networks 404. The gateway processor 408 typically acts as a master boot processor for the IP video telephone 402. The gateway processor 408 is typically an integrated, multiport PCI bridge system on a chip. In one embodiment, the gateway processor 408 comprises a Micrel KS 8695P processor. The KS 8695P integrates an ARM 922T CPU, a PCI bridge that can support up to three external PCI masters and a five port switch with integrated media access controllers and low power Ethernet PHYs. The PCI interface can be connected gluelessly to many PCI or card bus wireless LAN cards that support 802.11A/G/B. Those skilled in the art will recognize that other processors, chips or configurations could be used for the gateway processor 408.

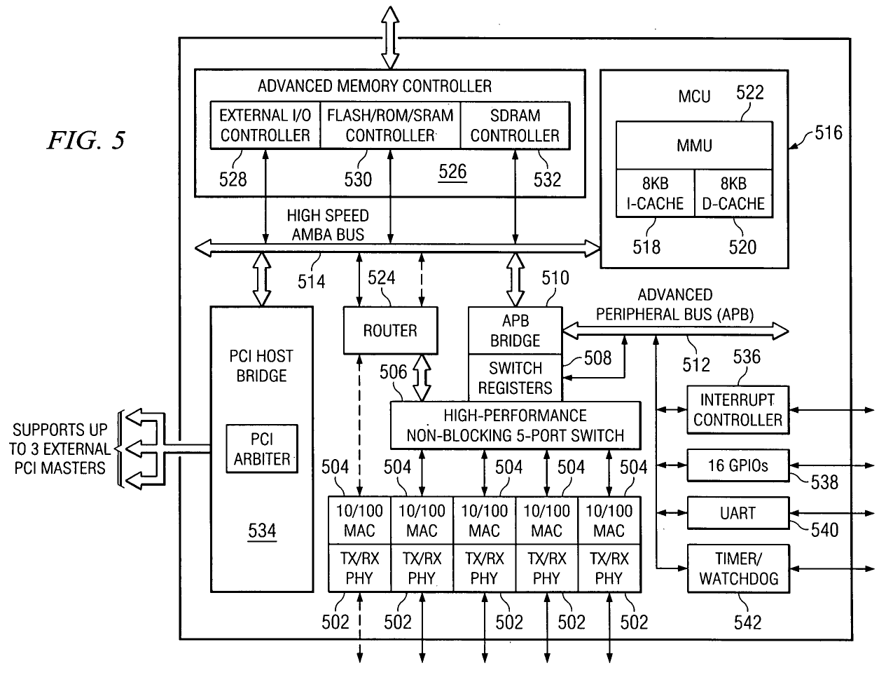

Referring now to FIG. 5, there is provided a functional block diagram of the gateway processor 408. The gateway processor 408 includes a plurality of transmit/receive PHY transceivers 502 enabling communications to and from the gateway processor 408. The transceivers 502 are mixed signal, low powered, fast Ethernet transceivers and have corresponding media access control units 504 associated therewith. A switching engine 506 moves data to and from the MACs 504. The switching engine 506 operates in a store and forward mode. Associated with the switch engine 506 are switch registers 508 and an APD bridge 510 for interconnecting the advanced peripheral bus (APB) 512 with the high speed AMBA bus 514. A microcontroller unit 516 controls operation of the gateway processor 408. The microcontroller unit 516 operates at 166 MHz and includes an 8 kilobyte I-cache 518 and an 8 kilobyte D-cache 520. A memory management unit 522 enables operation with Linex and WinCE®. A router 524 assists in the processing of packets transmitted by the gateway processor 408.

An advanced memory controller 526 includes an external input/output controller 528, a flash/ROM/SRAM controller 530 and an SDRAM controller 532. These controllers provide programmable 8/16/32 bit data and 22 bit address bus with up to 64 megabytes of total memory space for flash, ROM, SRAM, SDRAM and external peripherals. The PCI host bridge 534 supports three external PCI masters or guest mode and further a mini PCI and card bus peripheral. The PCI host bridge 534 supports a 33 MHz, 32 bit PCI interface. The gateway processor 408 further includes an interrupt controller 536 for generating interrupts in response to various interrupt conditions, 16 GPIOs for inputting and outputting data, a UART transceiver 540 and timer/watchdog circuitry 542 for timing various events.

Referring now back to FIG. 4, there are illustrated a link controller 410, USB controller 412 and mini PCI slot 414 connected to the gateway processor 408 via the PCI bridge 534. Likewise, the FLASH DRAM memory 416 is connected to the gateway processor 408 through the advanced memory controller 526. An Ethernet link 418 provides for interconnection between the gateway processor 408, a voice over IP processor 420 and a video processor 422. The voice over IP processor 420 is a communication processor providing audio, Codec and telephone management. In one embodiment, the VOIP processor 420 may comprise a teleology TNETV105 DSP.

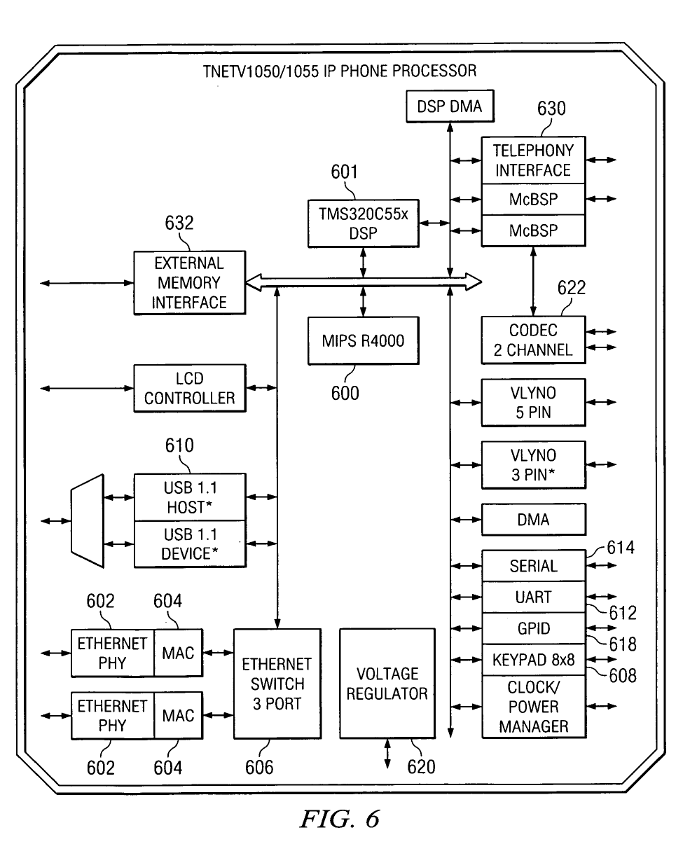

Referring now to FIG. 6, there is more fully illustrated one embodiment of the VOIP processor 408. Two 10/100 base T Ethernet PHY 602 and MAC 604 transceivers are included with an integrated layer to three port Ethernet switch 606. On-chip peripherals include an 8×8 keypad interface 608, a USB controller host 610, a UART serial interface 612, a programmable serial port 614 enabling serial port communications and a general purpose input/output interface 616. An integrated voltage regulator 620 provides for voltage regulation with respect to the VOIP processor 420. An integrated dual channel 16-bit voice codec integrates the coding/decoding functions necessary for IP phone applications and includes two analog-to-digital converters and two digital-to-analog converters. Other codec features include analog and digital side tone control, antialiasing filter, programmable gain options and programmable sampling rate. Other features of the VOIP processor 420 include analog-to-digital side tone control, filter, programmable gain options, programmable sampling rate, 8-bit speaker driver, microphone, and handset and headset interface 630.

The TNETV 1050 VOIP processor is a communications processor based on a MIPS 32 reduced instruction set computer (RISC) processor 600, along with a C55X digital signal processor (DSP) 601. The VOIP processor 420 has a rich peripheral set architect specifically for IP phone applications, which reduced the build materials costs, time and complexity associated with developing an IP phone. The RISC processor 600 supplies the overall system services and performs user interface, network management, protocol stack management, call processing and task scheduling functions. The DSP processor 601 provides real time voice processing functions such as echo cancellation, compression, PCM processing and tone generation/detection.

The external memory interface 632 supports two SDRAM chip selects providing 120 megabytes of memory space. The external memory interface 632 also supports three chip selects providing 16 megabytes each of RAM or ROM memory. Finally, the interface provides one chip select for providing a 32 megabyte flash memory.

Referring now back to FIG. 4, the VOIP processor 420 is connected to the flash/DRAM memory 424 through the external memory interface 632. The flash/DRAM memory 424 may comprise a flash memory, SDRAM or other suitable memory device. The VOIP processor 420 is also connected to a handset 426. The telephony interface 630 may also provide an interconnection for a cordless base 428 providing a wireless interconnection with a cordless handset 430. The voice over IP processor 420 may also be connected with a manual input device 432 to enable an individual to input information into the VOIP processor 420. Additionally, an audio out connection 434 provides for the ability to externally output audio information to the user of the IP video telephone 402. A microphone 436 enables the user to input audio information into the VOIP processor 420.

An embedded terminal adaptor 440 is interconnected with the VOIP processor 420 through a digital-to-analog and analog-to-digital interface 442. Information transmitted from the embedded terminal adaptor 504 is converted from analog into digital data by an analog-to-digital converter within the interface 442. Likewise, digital data coming from the VOIP processor 420 is converted into analog data for use by an analog telephone connected to the embedded terminal adaptor 440 by the interface 442. Information provided to the VOIP processor 420 by an analog telephone connected to the embedded terminal adaptor 440 is routed from the VOIP processor 420 to the gateway processor 408. The gateway processor 408 allows the data to be packetized and transmitted over the IP network 404 such that ultimately the data can be routed to another VOIP device connected to the IP network 404 or to an analog telephone connected to a PSTN network which is interconnected to the IP network 404.

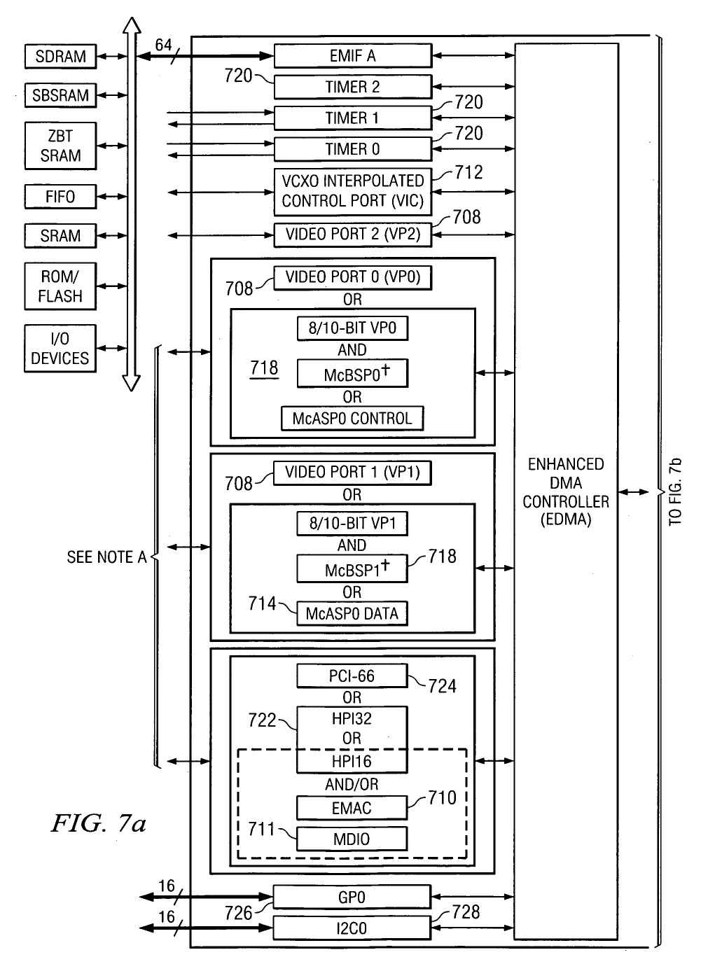

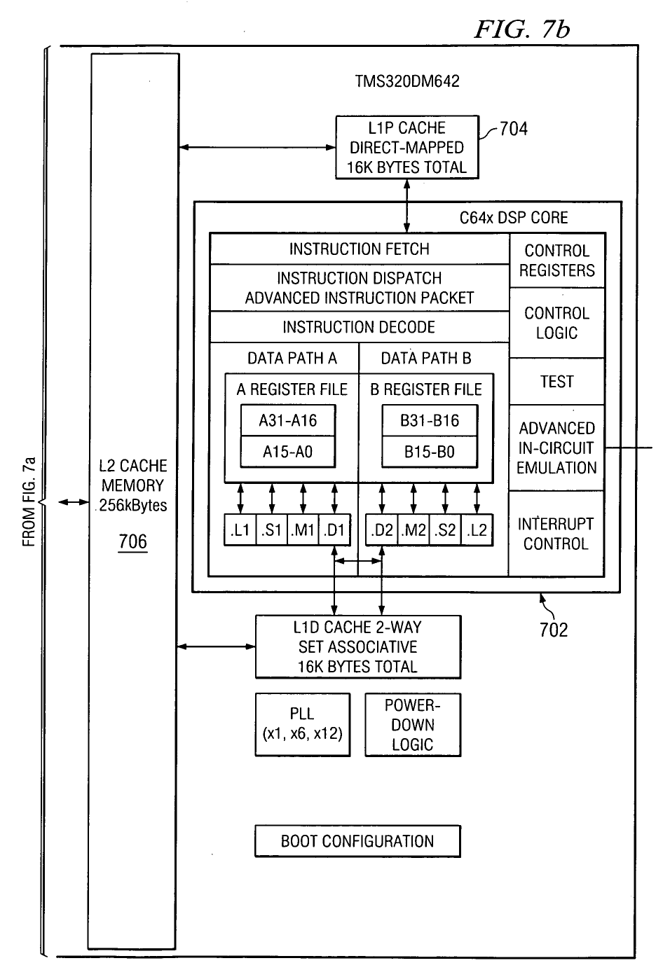

The video processor 422 is connected to the Ethernet link 418 to provide video capabilities for the IP video telephone 402. The video processor 422 includes a video Codec and LCD panel controller. The video processor 422 may in one embodiment comprise a TI TMS320DM642 digital signal processor. Referring now to FIG. 7, there is illustrated a functional block diagram of one embodiment of the video processor 422. The digital signal processor is based on the second generation high performance advance velociTI very long word instruction (VLIW) architecture. The digital signal processor may provide 4800 million instructions per second at a clock rate of 600 MHz. The DSP offers the flexibility of high speed controllers, and the numerical capability of array processors. A DSP core processor 702 has 64 general purpose registers of 32-bit word link and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals. The DSP typically uses a two level cache based architecture. A level one program cache 704 is a 128K bit direct mapped cache and a level one data cache is a 128-Kbit direct mapped cache and a Level 1 data cache is a 128-Kbit 2-way set-associative cache. A Level 2 memory cache 706 consists of a 2-Mbit-memory space that is shared between program and data space. Level 2 memory can be configured as mapped memory. Those skilled in the art will recognize that other DSP processors may be implemented.

The video processor 422 includes three configurable video port peripherals 708 (VP0, VP1 and VP2). These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels. The DSP video ports include a capture port interfaced with a Philips decoder with integrated multiplexer for NTSC, S-video sources; a display port interfaced with Philips SAA7105 NTSC and S-video encoder and a third port dedicated to the LCD panel.

The peripheral set further includes a 10/100 Mb/s Ethernet MAC; a management data input/output 711; a VCXO interpolated control port 712; a multichannel buffered audio serial port 714; an inter-integrated circuit bus module; two multichannel buffered serial ports 718; three 32-bit general purpose timers 720; a user-configurable 16-bit or 32-bit host port interface 722; a peripheral component interconnect 724; a 16-bit general-purpose input/output port 726 with programmable interrupt/even generation modes; and a 16-bit glueless external memory interface 728 which is capable of interfacing to synchronous and asynchronous memories and peripherals.

The multichannel buffered audio serial port transmitter 714 is programmed to output multiple encoded data channels simultaneously with a single RAM containing the full implementation of user data and channel status field. The multichannel buffered audio serial port 714 also provides extensive error checking and error features, such as bad clock deterioration circuit for each high frequency master clock which verifies that the master clock is within a program frequency range.

The Ethernet media access controller 710 provides an efficient interface between the DSP core processor and the Ethernet network 418. The media access controller 710 supports both 10-base T and 100-base T in either have or full duplex with hardware flow control and quality of service support. The Ethernet MAC 710 makes use of a customer interface to the DSP core that allows efficient data transmission and reception.

The management data input/output (MDIO) module 711 continuously pulls all 32 MDIO addresses in order to enumerate all PHY devices in the system. Once a PHY candidate has been selected by the DSP, the MDIO module transparently monitors its link state by rating the rating the PHY status register. Link change events are stored in the MDIO module 711 and can optionally interrupt the DSP, allowing the DSP to pull the link status of the device without continuously performing costly MDIO accesses.

The VCXO interpolated control (VIC) 712 port provides a digital-to-analog conversion with resolution from 9-bits to up to 16-bits. The output of the VIC 712 is a single bit interpolated D/A output.

The 12C0 port 728 on the video processor 422 enables the DSP to easily control peripheral devices and communicate with a host processor. Additionally, the standard multichannel buffered serial port (MCBSP) 718 may be used to communicate with serial peripheral interface (SPI) mode peripheral devices.

The video processor 422 connects with a video memory 446. The video memory 446 may comprise a flash memory, SDRAM, or other suitable memory device. The video processor 422 also connects to a video decoder 448. The video decoder may comprise an NTSC decoder for decoding provided video data. The video decoder 448 receives video signals from an external NTSC source 450 or from a video camera 452. The video processor 422 is also connected with a video encoder 454 that may comprise an NTSC encoder. The video encoder 454 may be integral with a CSC 156 to provide video signals to a RGB/LCD panel 158. The video encoder 454 may also provide video signals to an LCD panel 163 and a CV/S/RGB output 162.

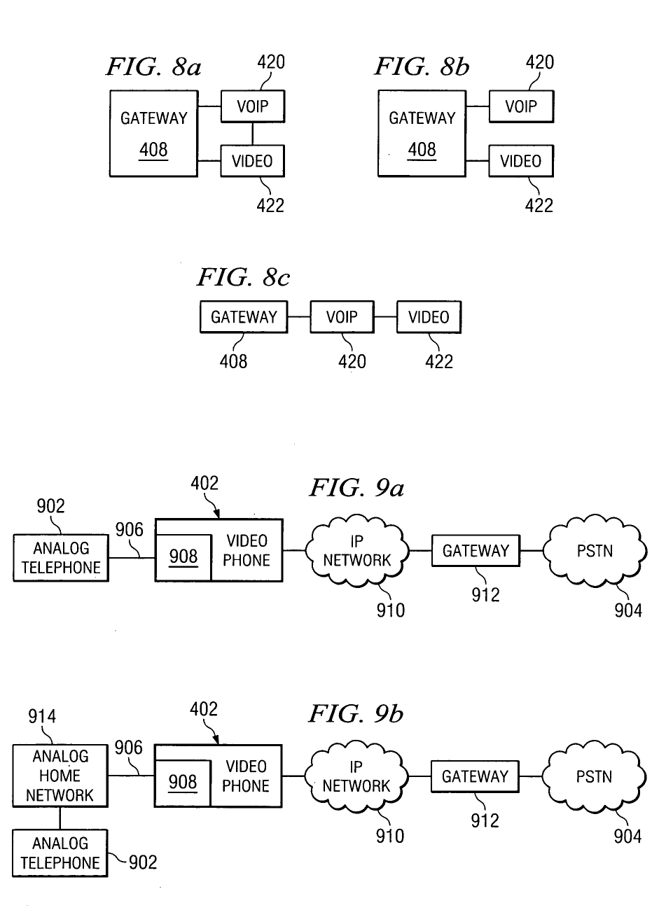

Referring now to FIG. 8a-8c, there is more fully illustrated the flexibility provided by the use of a gateway processor 408, VOIP processor 420 and video processor 422 that are able to communicate via an Ethernet network on a same board. FIG. 8a illustrates a first configuration of the gateway processor 408, voice over IP processor 420 and video processor 422. Each of these processors are included upon a same device board within the IP video telephone. In this configuration, each of the processors has an Ethernet connection with each of the other processors. Thus, the gateway processor 408 may communicate directly with the voice over IP processor 420 and the video processor 422. Also, the voice over IP processor 420 may communicate with each of the gateway processor 408 and the video processor 422, and finally, the video processor 422 may communicate with each of the gateway processor 408 and voice over IP processor 420.

FIG. 8b illustrates a configuration wherein only the gateway processor 408 may communicate with each of the voice over IP processor 420 and the video processor 422. When the video processor wishes to converse with the voice over IP processor 420, it must do so through the gateway processor 408. Thus, IP packet messages are transmitted from the video processor 422 to the gateway processor 408, and the gateway processor 408 then forwards the IP packets to the voice over IP processor 420. Likewise, when the voice over IP processor 420 desires to communicate with the video processor 422, it must forward packets to the gateway processor 408 which then forwards the packets onward to the video processor 422. As can be seen, each of the voice over IP processor 420 and video processor 422 may communicate directly with the gateway processor 408.

Finally, FIG. 8c illustrates a chained configuration wherein the gateway processor 408 communicates only with the voice over IP processor 420. The voice over IP processor 420 can communicate with either of the gateway processor 408 and the video processor 422. The video processor 422 only communicates with the voice over IP processor 420. All packets transmitted from the gateway processor to the video processor must be transmitted through the voice over IP processor 420, and likewise, all packets transmitted from the video processor 422 to the gateway processor 408 must be routed through the voice over IP processor 420.

The use of processing devices on the same board having packet network communications functionalities associated therewith enables an ease of configuration and updating with respect to the IP video telephone board. In this configuration, any of the processing chips used for either the voice over IP processor 420, gateway processor 408 and video processor 422 may be upgraded to a different chip or component by merely implementing the new chip within the board design. The only requirement is that the newly implemented chip must have the ability to transceive over an Ethernet network. Since the processors within the IP telephone board are each designed to carry out their various functionalities and communicate with the outside world using IP packets via an IP network, the use of differing components for these processors does not adversely affect the operation of the IP video telephone board.

Referring now to FIGS. 9a and 9b, there are illustrated the manners in which an analog telephone may be both connected to the PSTN network 904 through an IP video telephone 402. In this embodiment, the analog telephone 902 connects with the IP video phone 402 through an analog connection 906. The analog telephone 902 is plugged into the IP video telephone 402 at an embedded terminal adaptor 908. Embedded terminal adaptor 908 enables the IP video telephone 402 to accept analog signals from the analog telephone 402 and convert them into digital IP packet data that may be used to transmit over the IP network 910 to the PSTN network 904. The IP network 910 is connected to the PSTN network 904 through a gateway 912.

Referring now to FIG. 9b, there is illustrated an alternative embodiment wherein the analog telephone 902, rather than being plugged directly into the IP video telephone 402, is plugged into an analog home network 914. Rather than plugging the analog telephone 902 directly into the embedded terminal adaptor 908, the analog home network 914 is plugged into the embedded terminal adaptor 908. In this manner, analog telephones 902 within a home may be plugged into the existing telephone jacks of the home since the analog home telephone network is no longer directly connected to the PSTN network 904 but is instead connected to the IP video telephone 402. Signals generated by the analog telephone 902 are transmitted over the analog home network 914 to the IP video telephone 402 through the embedded terminal adaptor 908. These signals are converted to IP packet signals and provided over the IP network 910 to the public switched network 904 or other IP video phones connected to the Internet.

When connected in the manners illustrated in FIGS. 9a and 9b, the analog telephone 902 will operate as it normally does when connected with the PSTN network 904. The connection to the PSTN network 904 through the IP network 910 via the IP video telephone 402 is seamless to the user of the analog telephone 402.

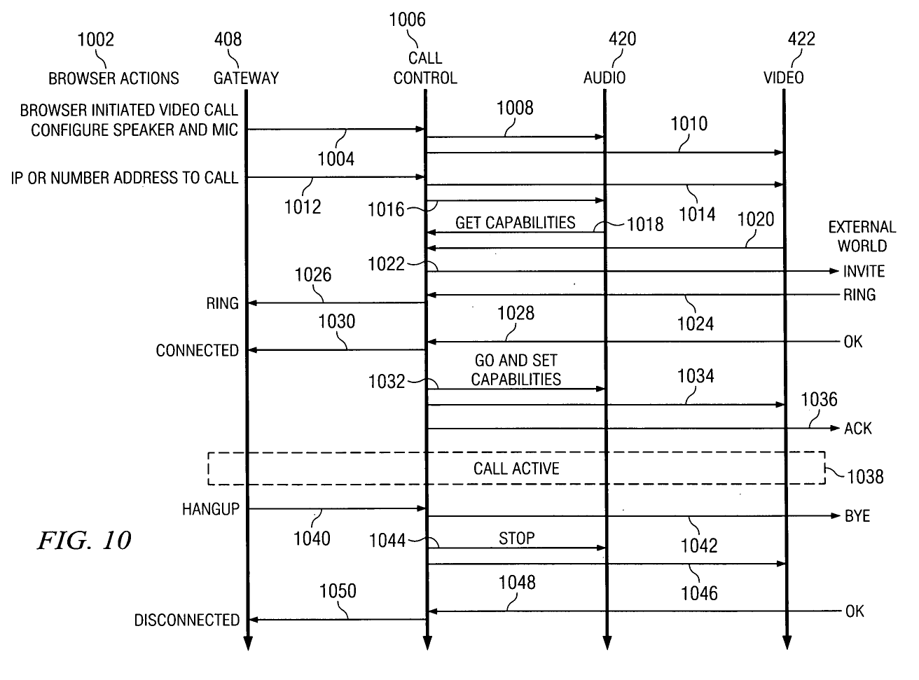

Referring now to FIG. 10, there is illustrated the process for providing a call connection and call disconnection using the IP video telephone of the present disclosure. Initially, a browser 1002 initiates a call by transmitting a message 1004 to call control 1006. The call control 1006 transmits a message 1008 to the audio processor 420 to configure the audio processor protocol. The call control 1006 also transmits a message 1010 to the video processor 422 to configure the video processor for operation. The gateway 408 provides the IP address or number address for the call at 1012. This information is provided to the video processor 422 at 1014 and to the audio processor 420 at 1016. The audio processor 420 provides the ability to provide audio support for the call at 1018, and the video processor 422 provides the capabilities for video processing for the call at 1020. The call control 1006 initiates the call to the external world at 1022.

A ring signal 1024 is provided from the external world back to the call control and the call control forwards the ring signal to the gateway processor and the call control 1000 forwards the ring signal to the gateway processor 408 at 1026. After the call is answered at the receiving end, an answer signal 1028 is provided from the external world to the call control 1006. The call control 1006 notifies the gateway 408 that the call is connected using a call connection signal 1030. The call controller 1006 notifies the audio processor 420 at 1032 that the call is connected and sets the capabilities for the call with the audio processor. The video processor 422 is notified at 1034 that the call is connected and sets the capabilities for the video processor 422. The call control 1006 transmits an acknowledge signal 1036 back to the external world to where the call has been answered. The call is supported by the IP video telephone during the time period 1038 for which the call is active.

Once the user has completed the call and hangs up the receiver of the IP video telephone, a hang-up signal 1040 is provided from the gateway 408 to call control 1006. The call control 1006 initiates a hang-up notification 1042 to the external world to the unit to which the IP video phone is connected. The call control 1006 initiates a stop signal 1044 to the audio processor 420 and a stop signal 1046 to the video processor 422 to indicate that the call has been disconnected. An acknowledgment 1048 is received from the external world at the call control 1006, and the call control notifies the gateway processor 408 that the call is disconnected at 1050.

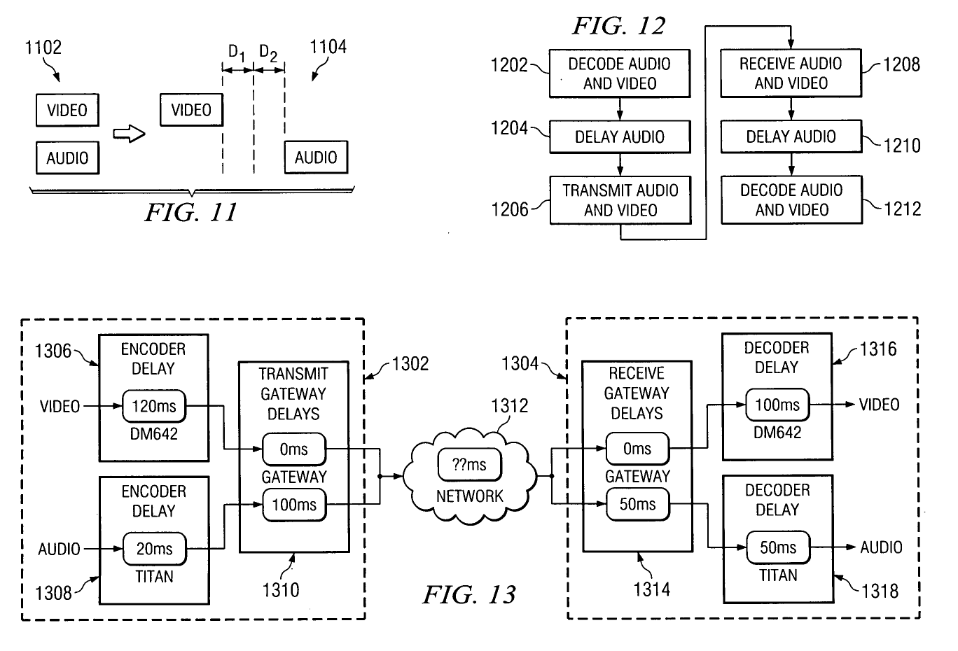

Referring now to FIG. 11, there is illustrated the problem of synchronization associated with the transmission of associated audio and video packets from a video phone at first location 1102 to a video phone at second location 1104. The video and audio encoding of the video and audio packets begins at the same time, and the packets are transmitted as the audio and video encoding are completed over an IP packet network such as the Internet. Decoding of the audio and video packets is begun upon receipt of said packets at the second location 1104. The process begins with the video and audio packets synchronized at location 1102. The packets will become unsynchronized by the time they arrive at location 1104 with the audio packets arriving for provision to a third party much sooner than the video packets. This is due to the inherent delays associated with the encoding/decoding of the video packet at both the first location 1102 and the second location 1104. The encoding of video packets at location 1102 takes longer than the encoding of audio packets. Thus, if the audio packets and video packets are transmitted as soon as they are ready, the audio packets will be transmitted prior to the video packets since the video packets will take longer to encode.

During transmission of the packets over the IP network, the assumption is that the packets sent at the same time will be grouped together as they are received and arrive at substantially the same time. However, when arriving at the second location 1104, the decoding of the video packet will again take longer than the decoding of the audio packet at the second location. Thus, the initial delay D₁ between the audio and video packets is caused by the encoding delays at the first location 1102 and the second delay D₂ is associated with the inherent decoding delay differences between the audio and video packets. Thus, a total delay of D₁+D₂ will be introduced between the audio and video packets resulting in a lack of synchronization between the audio and video packets at the receiving end.

One manner for minimizing or eliminating the lack of synchronization between the audio and video packets is illustrated in the flow chart of FIG. 12. The decoding of both the audio and video packets is begun at step 1202 with each of the associated audio and video packets being encoded in their normal fashion. However, once received at the gateway processor, the audio packets are delayed at step 1204 to an amount equal to the difference in the length of time it takes an audio packet and a video packet to be encoded. The received video packets and the delayed audio packets are transmitted at step 1206 to a second location 1104 from the first location 1102. The packets, both audio and video, are received substantially together at step 1208 at the second location 1104, and the audio packets are again delayed at step 1210 by an amount equal to the difference between the amount of time required to decode the audio packet from the amount of time to decode the video packet. The undelayed video packets and the delayed audio packets are decoded at step 1204 such that the completed decoding of associated packets will be provided at substantially the same time due to the delay introduced at the processing gateway of the receiving IP video telephone at location 1104. The introduced delay at the transmitting and receiving ends will cause the audio and video packets to be substantially synchronized.

Referring now to FIG. 13, there is more fully illustrated this process with respect to a pair of IP video telephones 1302 and 1304. The video to be encoded is input to the video processor 1306. The audio to be encoded is input to the audio processor 1308. The delay caused by the encoding is 20 milliseconds for the audio processor 1308 and 120 milliseconds for the video processor 1306. When these decoded packets are received at the gateway 1310, the audio packets are delayed by 100 milliseconds and the video packets are not delayed at all. This is due to the difference in delays associated with the encoding of the audio and video data. In this manner, associated audio and video data packets will be transmitted from the transmit gateway 1310 at substantially the same time.

The packets are transmitted over the associated IP network 1312 and statistically the packets will take the same pathway and arrive at a receive gateway 1314 at substantially the same time. The audio packets received at the receive gateway 1314 are delayed for 50 milliseconds while the video packets are not delayed at all and are passed on directly to the video decoder 1316. The provided video packets are decoded by the video decoder 1316 which takes approximately 100 milliseconds. After a delay of 50 milliseconds, the associated audio packets are forwarded to the audio decoder 1318 wherein the packets are decoded in approximately 50 milliseconds. Due to the induced delay of 50 milliseconds at the receive gateway 1314 for the audio packets, the audio packets provided from the audio decoder 1318 and the associated video packets from the video decoder 1316 will be output as associated video and audio packets at substantially the same time. This provides for a synchronized output at the IP video telephone 1104.

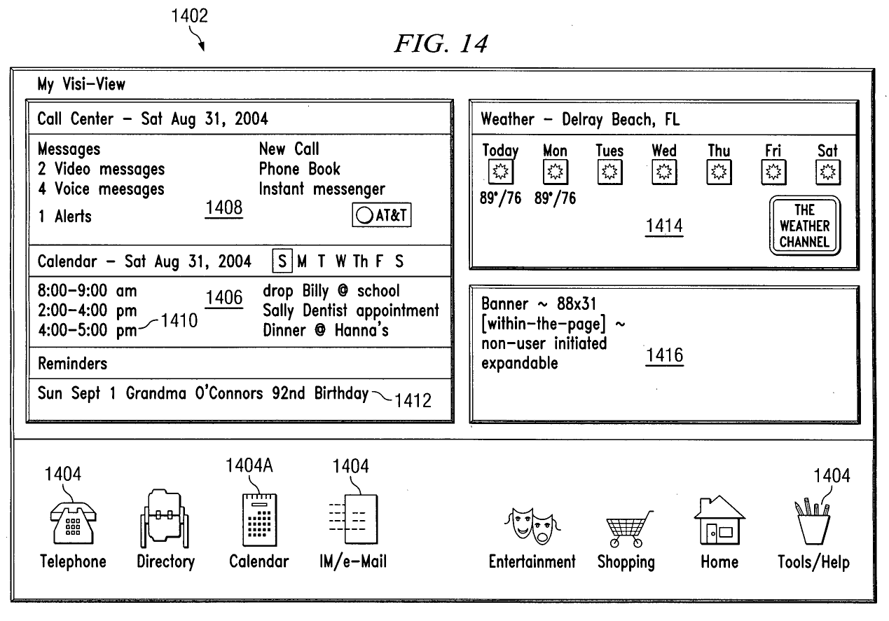

Referring now to FIG. 14, the IP video phone main display 1402 allows a user a quick and easy access to selection key applications each are which associated by a single touch button represented by a number of icons. The eight soft coded buttons 1404 that appear below the active display area 1406 correspond to specific activities or applications denoted by small icons that appear within the active display. For example, if a user selects and depresses the calendar button 1404a this will cause the IP video telephone to load and display a calendar application. The small icons on the bottom of the active display panel will vary depending upon the specific page or application that is selected by a user. As a result, each soft coded button 1404 will trigger or launch a specific and different activity or application relative to which active page or application is displayed. For example, if the user selects and depresses the button 1404a that corresponds to the calendar, this will result in loading the calendar application or load a web page that displays a user's personal calendar. When the calendar application is active, the icons that correspond to each of the buttons may differ than those as they appear in FIG. 14. The icons that would appear in the active calendar application would be relevant to the calendar application itself which will be more fully described hereinbelow.

The active display 1406 provides various information to the user. A message portion 1408 provides an indication of stored voice and video messages to the user. The calendar portion 1410 provides an abbreviated version of the user's calendar for the day and the ability to select a particular day of the week to view activities scheduled for that day. A reminders section 1412 provides various reminders that the user has programmed into the IP video telephone enabling them to be reminded of particular events or appointments. A weather display 1414 provides various information to the user on current and coming weather conditions for various days of the week. Finally, an ad window 1416 provides for the placement of banner ads that have been purchased by various advertisers that have a business relationship with the service provider of the IP video telephone. While the foregoing description describes one particular embodiment of the display associated with the IP video telephone, it will be realized by one skilled in the art that the above-described displays and the particular descriptions of the displays following herewith comprise only a single embodiment and numerous changes and alterations to the display may be made to suit a particular user and/or service provider.

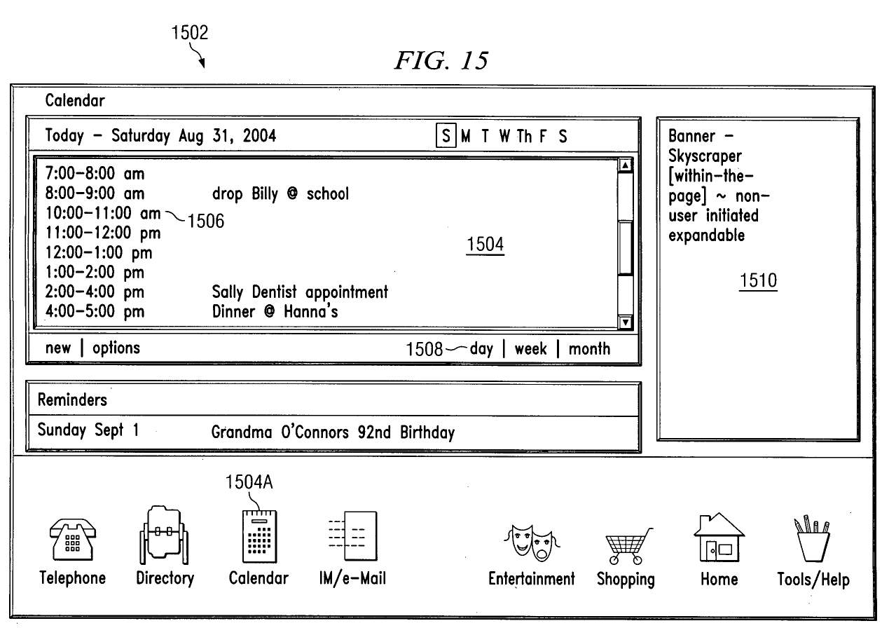

Referring now to FIG. 15, the calendar display screen 1502 provides a user with more detailed calendar information as well as enables the user to add, edit or view various individual family members' calendars. Users will have the ability to upload and download personal calendars form external sources and devices including, but not limited to, PDAs, Microsoft Outlook and Eudora. Users would also have the ability to view their personal calendars stored within the IP video telephone away from the IP video telephone as long as they have access to an Internet connection and a web browser. The active display 1504 associated with the calendar button 1404a includes a screen displaying the calendar items for today. The calendar includes options 1508 for displaying a day, week or month configuration on the calendar and an advertisement window 1510 enables banner ads to be displayed to the IP telephone user.

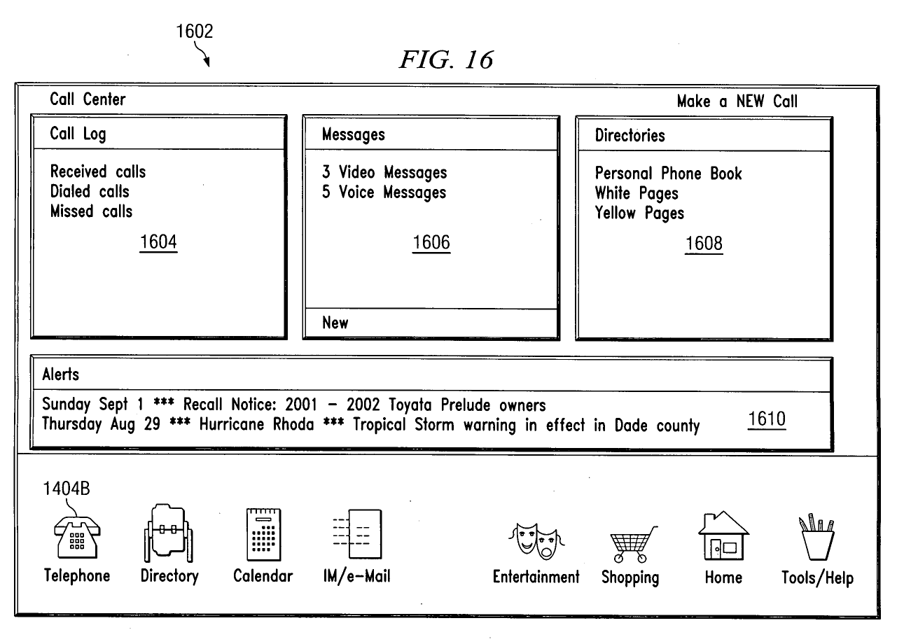

Referring now to FIG. 16, the telephone display screen 1602 is displayed responsive to pressing the telephone display button 1504b. The telephone display screen 1602 allows a user an overall view and access to call center applications including call log, audio and video messages, directories and telephone listings, alert notifications and the IP telephone's dial pad to make a telephone or video call. Text within the call log pane 1604, message pane 1606 and directory pane 1608 are hot linkable. A user is able to drill down and view more detailed information within the selected window panes by simply using a tethered stylis and touching a respective hot link. For example, if a user selects and touches “Receive Calls” hot link in the call log window pane 1604, the user will be able to review all of the received calls that have been stored within the memory of the IP video telephone.

The call log pane 1604 additionally provides information on previously dialed calls and missed calls. The messages pane 1606 provides listing of both video and voice messages that have been received and stored for a user. The directories pane 1608 provides access to various telephone directories including a personally created phone book, a white pages or a yellow pages. An alerts pane 1610 may provide either information previously indicated by the user as important to the user for which they wish to wish alerts upon, or alternatively, may be directed information pushed to the user based upon data mining analysis with respect to the user's call and/or interest activities.

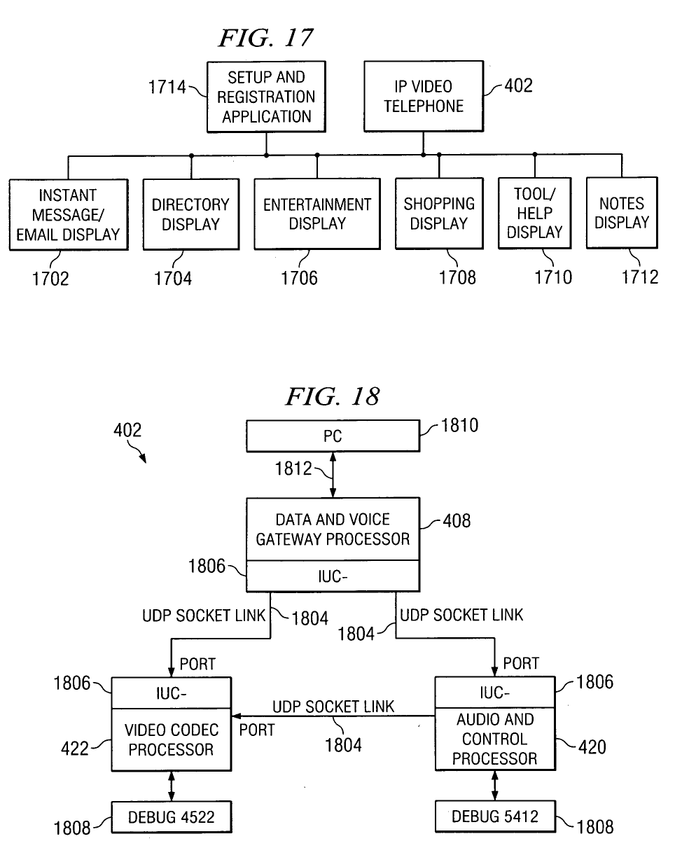

In addition to the displays described above, the IP video telephone may also include the displays illustrated in FIG. 17. The instant message/email display 1702 enables the video phone 402 to display instant messaging messages and email messages. Additionally the instant message/email display 1702 enables the creation of these kinds of messages. The directory display 1704 provides a listing of all telephone numbers that a user has stored for point and click dialing or may provide network access to publically available directories. The entertainment display 1706 displays various entertainment content that an IP telephone user has either has programmed in themselves or has been determined to be of interest to the user by a host server providing service to the IP video telephone 402. The shopping display 1708 displays various content providers that a user has indicated an interest in shopping from or displays content providers than the host server has determined a user may have an interest in shopping from the provider. The tool/help display 1710 provides an interface enabling a user to solve various problems or receive how to descriptions for the video telephone. The display 1710 includes a search screen enabling a user to search available information and a index screen with an index of available information. The notes display 1712 provides a display enabling users to leave messages or reminders to themselves or another. A note display icon may be displayed responsive to an open note. The setup and registration application display 1714 provides a user with the ability to setup and register their IP video telephone 402 with the network and a host server. Relevant information and system parameters are entered through this display.

Referring now to FIG. 18, there is illustrated a block diagram describing the manner in which the data and voice gateway processor 110, the video codec processor 114 and the audio VOIP processor 111 may carry out inter unit communications (IUC) between each of the associated devices. Communications between each of the data and voice gateway processor 110, video codec processor 114 and audio VOIP processor 111 are carried out via UDP socket link connections 1804. Communications over the UDP socket links 1804 are enabled via IUC control software 1806 stored within each of the units. The video codec processor 114 and the audio VOIP processor 111 additionally include debugging functionalities 1808 to enable the debugging of communications problems within each of these devices. The data and voice gateway processor 110 may additionally communicate with an external PC 1810 via a communications link 1812. The IUC handler 1806 on each processor uses the TCP/IP socket communications protocol as the transport layer between the various devices. The IUC handler 1806 additionally statically initializes and builds the UDP port on specific applications. The IUC handler 1806 enables command and communications between the processors to be based upon a TEXT/ASCII string. Each IUC handler 1806 converts TEXT/ASCII strings to a hexadecimal command structure. The IUC handler's 1806 other functionalities include providing a clock signal to keep processors alive, provisioning data for transportation through IUC socket connections and providing pay load data through different claims. Interdevice communications use a local area network (LAN) Ethernet transport, TCP/IP protocol, and optionally may communicate via an onboard LAN card with an external PC 1810.

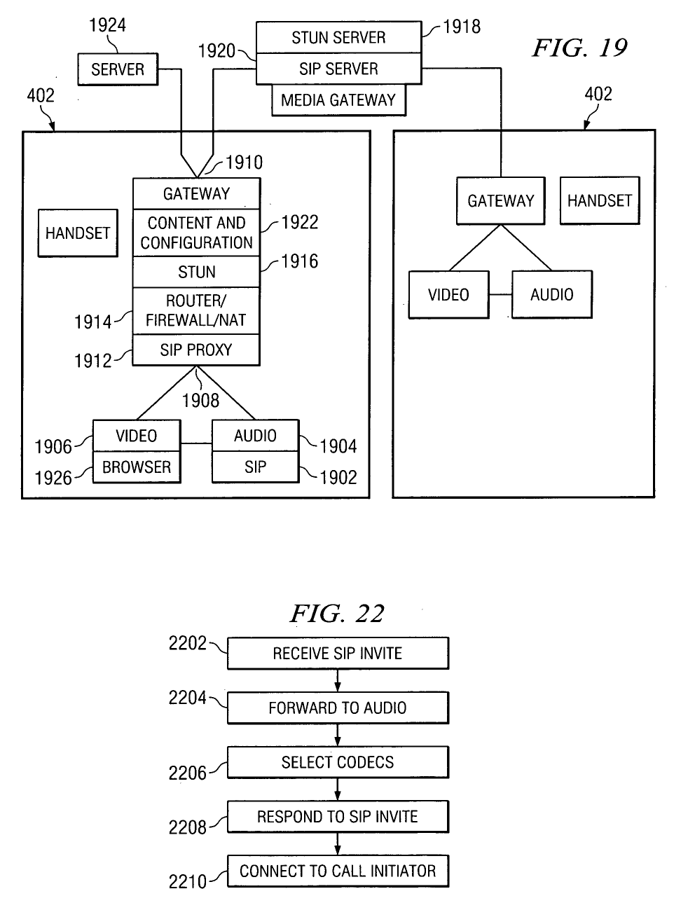

Referring now to FIG. 19, there is more fully illustrated a pair of IP video telephones 402 and the software modules associated therewith enabling call connections between a pair of IP video telephones 402 and enabling the provision of content to a display of the IP video telephone 402 via the Internet. As described previously, the video telephone 402 consists of the gateway processor 110, audio processor 114, video processor 111 and a telephone handset 104 providing a user interface with the functionalities of the video telephone 402. The audio processor 114 includes a SIP module 1902 enabling the video telephone 402 to set up calls over the Internet using a voice over IP functionality to carry out the calls. Calling between video telephones 402 is enabled via the SIP (session initiation protocol) protocol.

SIP is a signaling protocol for Internet conference, telephony, presence, event notification and instant messaging. SIP provides the necessary protocol mechanisms so that systems and proxy server can provide services such as call forwarding; callee and calling “number” delivery, where numbers can be any (preferably unique) naming scheme; personal mobility, i.e., the ability to reach a called party under a single, location independent address even when the user changes terminals; terminal type negotiation and selection wherein a caller can be given a choice how to reach the party such as via Internet telephone, mobile phone, an answering service, etc.; terminal capability negotiation; caller and callee authentication; blind and supervised call transfer; and invitations to multicast conferences. Extensions of SIP allow third party signaling such as quick to dial services, fully meshed conferences and connections to multipoint control units, as well as mixed mode and the transition between those. SIP addresses users by an email-like address and reuses some of the infrastructure of electronic mail delivery such as DNSMX records or using SMTPEXPN for address expansions. SIP addresses (URLs) can also be embedded in web pages. SIP is addressing neutral, with addresses expressed as URLs of various types such as SIP, H.323 or telephone (E.164). SIP is independent of the packet layer and only requires an unreliable datagram service, as it provides its own reliability mechanism.

The data port 1904 of the audio processor 114, the data port 1906 of the video processor 111 and the data port 1908 of the gateway processor 110 each have unique internal IP addresses associated therewith that are used only within the video telephone 402. These unique IP addresses are different from the IP address associated with the data port 1910 with which the IP video telephone 402 is connected with the external world from the gateway processor 110. In order for data packets to be transmitted between the audio processor 114 and the video processor 111 to the external IP network through the gateway processor 110. The Ethernet and SIP addresses used within the internal Ethernet network and over the external IP network must be translated. Thus, when data packets are transmitted to the gateway processor 110, the SIP proxy 1912 is responsible for converting the SIP protocol addresses from the address utilized by the audio processor 114 to the SIP protocol address used at the output of the gateway processor 110. The SIP proxy module 1912 additionally converts the address of video packets from the video processor 111 to the address of the output of the gateway processor 110. The SIP proxy 1912 additionally includes the capability for routing audio stream packets to/from the audio processor 114 and video stream packets coming to/from the video processor 111 at the same time. The SIP proxy 1912 achieves this by transmitting the video packets as a second audio stream of larger audio packets. The SIP proxy 1912 believes it is transmitting a second audio stream when in fact it is transmitting the stream of video packets from the video processor. The router/firewall/NAT 1914 is responsible for translating addresses from packets received from the audio processor 114 and the video processor 111 in the ethernet domain. The packets from the audio and video processors have the IP port addresses from the outputs of both the audio and video processors. The router/firewall/NAT 1914 converts the addresses of these output ports to the address of the output port 1910 of the gateway processor 110 at the Ethernet level.

The stun module 1916 is utilized to enable the gateway processor 110 of the video telephone 402 to determine the IP address by which the outside world views the video telephone. The stun module 1916 does this by transmitting messages to a stun server 1918 associated with the SIP server 1920 enabling call connections. The stun server 1918 transmits a response back to the stun module 1916 indicating the outside world's view of data from the IP video telephone 402.

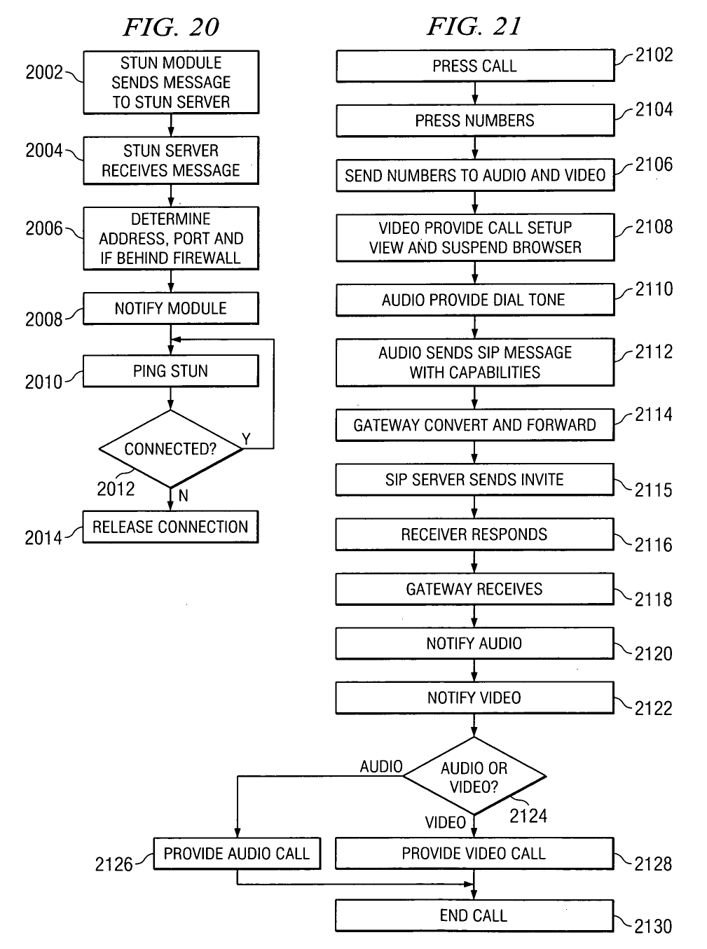

Referring now also to FIG. 20, there is more fully illustrated the manner in which the stun module 1916 is able to determine the way in which the outside world views the associated video telephone and in which the stun module 1916 provides an open port connection between the SIP server 1920 and a video telephone 402 by which an outside caller may connect to the video telephone 402. The stun module 1916 sends a message to the stun server 1918 at step 2002. The stun server 1918 receives at step 2004 the message from the stun module 1916 and determines at step 2006 the address associated with the video telephone 402 transmitting the stun server message, the port from which the stun server message is being transmitted and whether or not the data being transmitted from the video telephone is coming from behind a firewall. Responsive to this determination, the stun server 1918 notifies the stun module 1916 of its determinations at step 2008. Utilizing this information, the stun module 1916 periodically transmits messages to the stun server 1918 at step 2010 in order to maintain a connection between the video telephone 402 and the SIP server 1920. This periodic pinging to the stun server 1918 will continue as long as inquiry step 2012 determines that the video telephone is still connected to the network. Once inquiry step 2012 determines that the video telephone 402 is no longer connected, the connection is released at step 2014. The purpose for maintaining the connection between the stun server 1918 associated with the SIP server 1920 and the video telephone 402 is to enable incoming calls to be received by the video telephone. If the connection through the stun server were not maintained, the gateway processor 110 of the video telephone 402 would view an incoming message as an attempt to improperly access the gateway processor 110. By maintaining the connection between the stun module 1916 and the stun server 1918, the connection may be used to transmit incoming calls by transmitting SIP protocol messages over the connection to the gateway processor 110 of a receiving video telephone 402.

The content and configuration module 1922 enables control of the configuration of the audio processor 114 and the video processor 111. All operating parameters within these two processors are controllable through the content and configuration module 1922. One parameter the content and configuration module 1922 may set is the codec with which the audio and video processors process incoming and outgoing data packets. The audio processor may be configured to operate according to the G.711, G.722, G.720 or any other available audio codec with which the audio processor 114 may operate. Likewise, the video processor 111 may be configured to code/decode video packet data according to H.264, H.263 or other types of video codecs. In the preferred embodiment, the configuration parameters may be set within the content and configuration module 1922 from an external host server 1924. This external server may download these parameters into the content and configuration module 1922 and the content and configuration module 1922 may then download the appropriate parameters to the video processor 111 and the audio processor 114 through the internal ethernet.

The content and configuration module 1922 is also able to control the content which is displayed by the browser 1926 within the video processor 111. The browser 1926 operates as an Internet browser providing the ability for the video processor 111 to display various web page content upon the display of the video telephone 402. Content may be established within the content and configuration module 1922 either by the user of the video telephone 402 selecting display preferences or controlling browsing of the Internet through the browser 1926 using, for example, the handset 104. Alternatively, the external server 1924 may push content to the content and configuration module 1922 in order to enable external content providers to display, for example, directed advertising information on the browser 1926 of the video telephone 402. Thus, the content portion of the content and configuration module 1922 may be either controlled locally via the user of the video telephone 402 or externally via a content provider providing a server 1924 interconnected with the video telephone 402.

Referring now to FIG. 21, there is a flow diagram illustrating the manner in which a call connection may be created between a first video phone and an external video phone or non-video phone. Initially, the user presses a call button on the handset of the video telephone at step 2102. After pressing the call button, the user presses in the numbers associated with the called party at step 2104. The gateway processor 110 sends the dialed numbers at step 2106 to both the audio processor 114 and the video processor 111. Responsive to the received numbers, the video processor 111 provides at step 2108 a call setup view in the display and suspends operation of the browser 1926. The call setup view provides a visual indication to the user such as a “called number” display or “call ringing” indication when the call is ringing on the called line. Responsive to the receipt of the dialed numbers from the gateway processor 110, the audio processor 114 provides at step 2110 a dial tone indicating that an outgoing call line has been accessed. The dial tone is provided by the SIP functionalities 1902 within the audio processor 114.

The audio processor 114 sends at step 2112 a SIP message to the gateway processor 110. The SIP message includes the audio and visual codec capabilities of the calling video telephone 402. The gateway processor 110 converts the IP addresses associated with the SIP protocol and the IP addresses associated with the Ethernet protocol to the appropriate addresses using the SIP proxy 1912 and router/firewall/NAT module 1914 and forwards this information to the SIP server 1920. The SIP server 1920 generates a SIP invite at 2115 which is forwarded to the called party. The called party responds to the received SIP invite at step 2116, and the gateway processor 110 receives at step 2118 the called party's response. The appropriate address conversions are made by the router/firewall/NAT module 1914 and SIP proxy 1912 at the gateway 110 such that the audio processor 114 may be notified at step 1920 of the completion or non-completion of the call. Once the call is connected, the video processor 111 is notified at step 2122 by the audio processor 114 of the call connection. Inquiry step 1924 determines if the called party enables provision of an audio only or an audio/video call. If only audio is provided, an audio call is provided at step 2126. If an audio/video call is indicative, the video call is provided at step 2128. The call continues until the call is ended at step 2130.

If the called party is using another video telephone according to the type described hereinabove, the receipt of a SIP server invite would cause the operation as illustrated in the flow chart of FIG. 22. Initially, the SIP invite is received by the gateway processor 110 at step 2202. The gateway processor 110 forwards the SIP invite at step 2204 to the audio processor 114. The audio processor 114 is able to read all of the codecs indicated within the received invite provided by the calling party and select the appropriate codecs at step 2206 for use with the call. Thus, if the video telephone 402 provides both audio and video capabilities, the video phone would select both an audio codec and a video codec for processing the call. Next, the audio processor 114 responds to the SIP invite at step 2108 indicating the codecs that will be used for completion of the call connection. This operation within the audio processor 114 is carried out by the SIP functionality 1902. Finally, the audio processor 114 and video processor 111 are able to connect with the calling party at step 2210 utilizing the selected codecs to provide a video telephone call between the calling party and the called party.

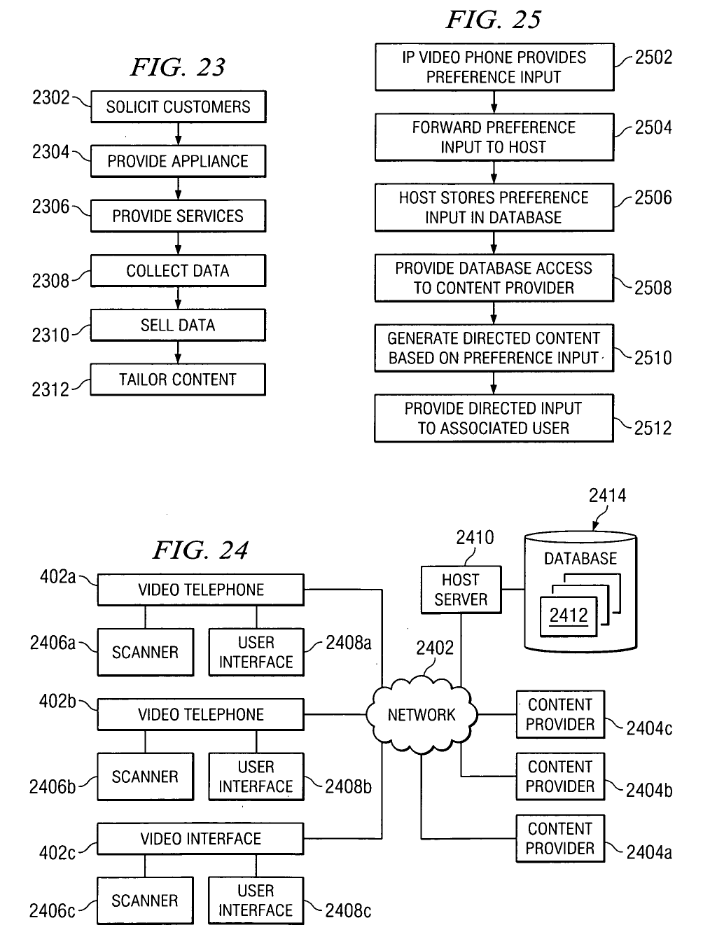

Referring now to FIG. 23, it will be appreciated that the IP video telephone 402 described hereinabove may be utilized to create an IP video telephone network providing a number of services to customers in much the same way as the cellular telephone industry provides cellular services to cellular telephone customers. The process for providing IP video telephone services as illustrated in FIG. 23 is initiated by the solicitation of customers at step 2302 to subscribe to the IP video telephone network. Once an individual has agreed to become a customer of the IP video telephone network, the customer is provided at step 2304 with the IP video telephone 402. The IP video telephone 402 can be provided to the consumer without cost, and the customer can only be charged for connection services to the IP video telephone network. Alternatively, the customer could be provided with both the IP video telephone 402 and the right to connect with the IP video telephone network without charge. In this case, the IP video telephone network provider generates income from other services provided by the network.

Once the customer has been provided with an IP video telephone at step 2304, the network provides services to the customer at step 2306. In the process of providing services to the customer, the IP video telephone network would have the ability to collect data at step 2308 relating to various user preferences, web sites accessed by the IP video telephone 402, numbers called and similar types of data providing information related to a user's commercial preferences. This type of data is collected at step 2308 and stored within a data base associated with a host server supporting the IP video network. The data collected relates to the consumer, the consumer's demographics and personal buying habits of the consumer. The IP video telephone network provider sells this data at step 2310 to content providers, and the consumer data sold to the content providers is used to tailor the audio/visual content provided to the user at step 2312. Thus, for example, if the web browsing activity of a particular IP video telephone user indicates an interest in snow skiing, a travel content provider providing travel services to ski resorts could purchase this information and direct advertising content to the user through the IP video telephone related to ski trip packages.

Referring now to FIG. 24, there is illustrated the overall network system for providing directed user content to various IP video telephones 402 as described in FIG. 23. A number of IP video telephone telephones 402 are each connected with an IP network 2402, such as the Internet, to enable call connections between the IP video telephones 402 and to enable the IP video telephones 402 to access various content providers 2404. Each IP video telephone 402 has associated therewith a scanner 2406 and a user interface 2408. The scanner 2406 enables a user of the video telephone 402 to scan various information into the video telephone that may be transferred from the video telephone over the IP network 2402 to a host server 2410. The host server 2410 stores the information within individual user files 2412 within a database 2414. The demographic data entered through the scanner 2406 of FIG. 24 may result from the scan of codes associated with print advertisements, codes associated with purchase products, codes input from other media sources, acknowledgments or requests for further information of media content displayed on the IP video telephone 402. The user interface 2408 is used to manually enter preference information into the IP video telephone 402 which may also be stored within the user files 2412 of the database 2414. This information may include web site addresses accessed by the user of the IP video telephone 402, purchases made by a user from various content providers 2404, web broadcasts accessed and received by the user of the IP video telephone 402 from a particular content provider 2404, or any other type of information transmitted over the IP network 2402 which may provide some insight as to particular interest or buying preferences that may be stored within the user's file 2412.

As mentioned previously, the host server 2410 has the ability to collect all of the information entered into the video telephone by the scanner 2406 and the user interface 2408 in order to index and store this information within the database 2414. The database 2414 contains a plurality of user files 2412 that are each uniquely associated with a particular IP video telephone 402. The host server provider generates an income stream by selling the information within the various user files 2412 to content providers 2404. The content providers 2404 use the stored user information within the user files 2412 to generate content specific advertising to various users of an IP video telephone 402. Thus, if content provider 2404b was a retail outlet providing sporting good supplies, and it was determined that a user of IP video telephone 402b had an interest in outdoor activities, the content provider 2404b could direct specific advertising only to video telephone 402b and not to video telephones 402a and 402c. In this way, the user of video telephone 402b is more likely to be exposed to advertising that the user will have an interest in, rather than having the user bombarded with a volume of advertising in which the user has no interest. Each content provider 2404 generates media content including audio or video programming such as advertisements, informational or educational content, entertainment content, interactive communication content, or other AV content. In response to a consumer request from an IP video telephone 402 or indication inferred from a user file 2412, the content provider 2404 provides media content to the video telephones 402. The sale of this directed user information in the user files 2412 by the provider of the host server 2410 is one manner in which a revenue stream is generated by the network provider without charging for the video telephones 402 or connection to the network.

Referring now to FIG. 25, there is illustrated a flow diagram more particularly illustrating the manner in which particular user preferences may be used by a content provider to provide content tailored for the demographics of the specific household or user. Initially, the IP video telephone 402 provides various preference inputs at step 2502 through, for example, the scanner 2406 or user interface 2408 discussed hereinabove. These preference inputs may indicate particular interests or areas of interests that a user or household associated with the IP video telephone have. The IP video telephone 402 forwards the preference inputs to the host server 2410 at step 2505. The host server 2410 is able to process these preferences and store them at step 2506 within the associated user file 2412 of the IP video telephone 402 within the database 2414. A content provider 2404 is provided at step 2508, access to the database 2414 by the host server. The content providers 2404 utilize the associated customer files 2412 to generate directed content at step 2510 based upon the preference inputs stored within the various user files 2412 of the database 2414. In this use, only certain of the user files 2412 would be used by any particular content provider 2404 since each content provider would not necessarily provide content that was of interest to a user or household associated with every IP video telephone 402. The content provider generates their directed content at step 2510 based upon the preference inputs and provides the directed content at step 2512 to the associated IP video telephone 402 from which the preference inputs were received from the user file 2412.

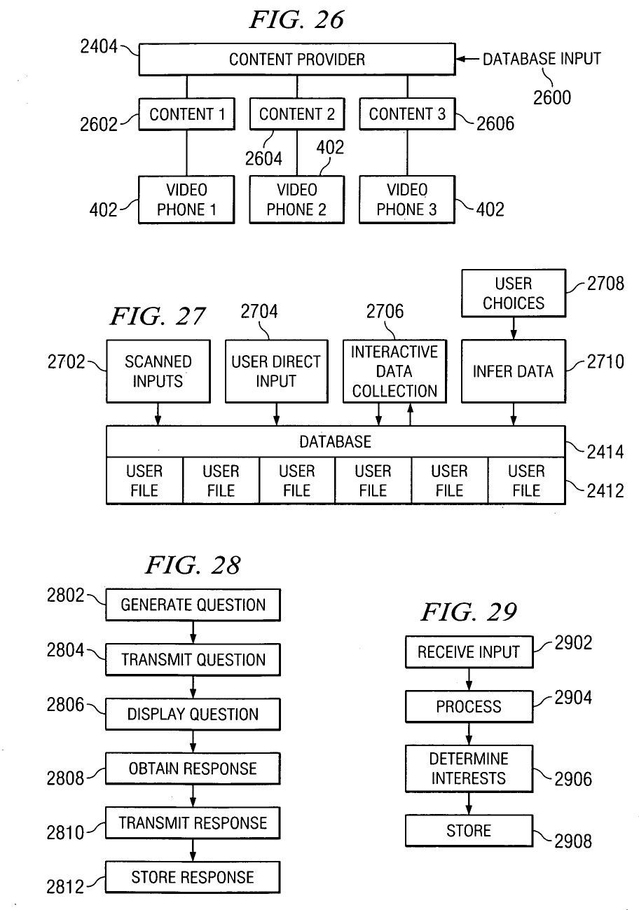

Referring now to FIG. 26, there is provided an illustration of the manner in which specific directed content may be generated for a number of IP video telephones 402. The content provider 2404 receives a database input 2600 that provides a number of preferences associated with users of various IP video telephones 402. Using the database input 2600, the content provider 2404 generates directed content that is transmitted to particular IP video telephones 402. Content A is generated and particularly associated with video telephone A. This information could have hiking and camping content associated therewith. Content provider 2404 could generate content B specifically directed to video telephone B for a user interested in fishing. Finally, the user of video telephone C might have a particular interest in sky diving, and the content provider 2404 would generate sky diving specific content C to be directed to the video telephone C. Since the IP addresses of each of the associated video telephones 402 are known by the host server 2410, the content generated by a content provider 2404 may be sent specifically to the IP video telephone from the content provider 2404 rather than being generally broadcast to each of the IP video telephones 402. Thus, the content is specifically directed to the interests and desires of a particular user or household associated with a video telephone 402.

Referring now to FIG. 27, there is more particularly illustrated the manner in which various inputs may be provided to the database 2414 such that the inputs may be stored in an associated user file 2412. The database 2414, as described previously is associated with the host server 2410 providing services to a number of IP video telephones 402. The database 2414 has stored therein a plurality of user files 2412 with each user file associated with a particular IP video telephone 402. The data is provided to the database 2414 and then stored individually within each user file 2412. The data may be entered in a number of fashions. Scanned inputs 2702 may be input into the database 2014 from the scanner devices attached to the IP video telephone 402. These scanned inputs may comprise scanned codes from products themselves, from advertisements, magazines, newspapers or any other physical item which has associated therewith a particular code that directs a user to a particular content provider or web site. Input may also be provided to the database 2714 in the form of user direct input 2704. Direct inputs 2704 comprise codes or data manually entered by the user in order to access particular content providers or may comprise indications of particular web sites or content providers that are accessed by the user using their IP video telephone 402. Another method for obtaining data to be stored within a user file 2414 involves interactive data collection 2706. Interactive data collection 2706 involves the transmission of some type of message or request to one or more IP video telephone 402 by the host server 2410, collecting the responses provided by the users and storing these responses within the associated user files 2412.

This process for interactive data collection is more particularly illustrated in FIG. 28. A question is initially generated at step 2802 for a number of IP video telephones 402 by the host server 2410. The host server 2410 transmits the question to the plurality of IP video telephones 402 at step 2804. Upon receipt of the question by an IP video telephone 402, the question is displayed at step 2806, and the user is given the opportunity to respond to the question in order to provide input data that may be stored within the user file 2512 associated with the IP video telephone 402. A response is obtained at step 2808 by the user entering some code or responding by providing manual input to the displayed question. The provided response is transmitted at step 2810 back to the host server 2410 and the provided response is stored at step 2812 within the database 2414, and more specifically, within the particular user file 2412 associated with the IP video telephone 402 providing the response.

Referring now back to FIG. 27, another manner for providing data for storage within a user file 2412 of the database 2414 is analyzing a user's choices 2708 that are made with respect to the IP video telephone 402. This would include particular locations that the user has access via the browser functionalities of the IP video telephone or specific locations that may have been called or contacted on the IP video telephone 402. The user choices 2708 are analyzed such that the host server may infer data 2710 that would be valuable to a content provider 2404 in indicating a particular user's preferences. This inferred data 2710 is stored within the database 2414 for each user file 2412 for which inferential data has been created.

Referring now to FIG. 29, there is a flow diagram illustrating the manner in which user preferences may be inferred from received user choices 2708. Inputs from a particular IP video telephone are received at step 2902 from choices and selection the user makes as to who they are calling and what content providers they may be viewing through the web site browser functionalities of the IP video telephone 402. These choices are processed at step 2904 such that the interests of the user may be determined at step 2906. From the locations that a user has been viewing, various interests can be determined such that, for example, if a user is always accessing skateboarding web sites, a determination may be made that advertisements for skateboards would be of interest to at least one member of the household associated with the IP video telephone 402. Once these interests are determined at step 2906, they are stored within the user file 2412 at step 2908. These interests are provided to various content providers 2404 to assist then in their directed advertising efforts.

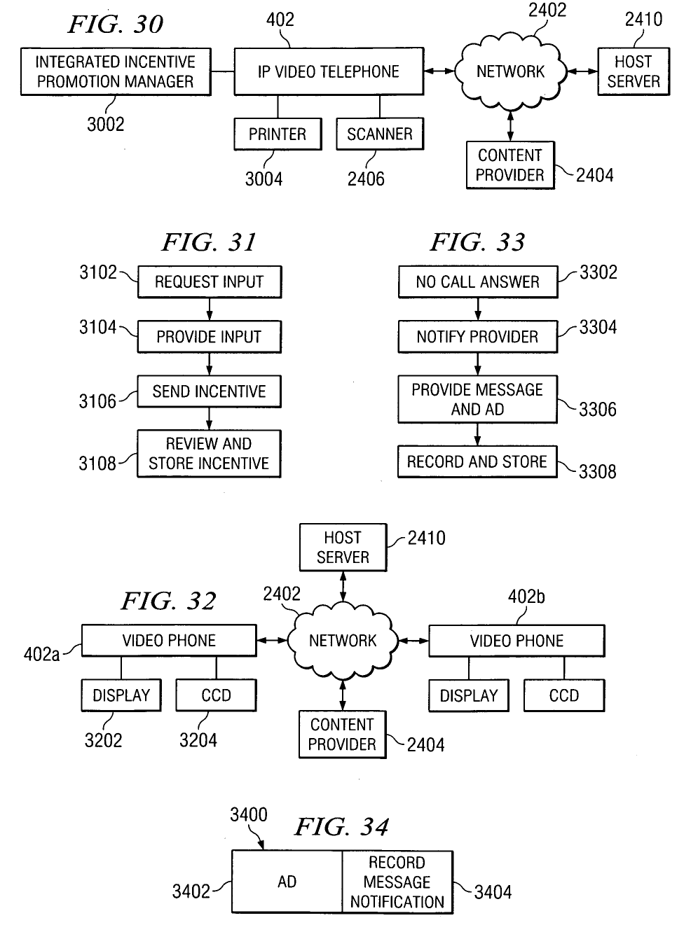

Referring now to FIG. 30, there is illustrated an IP video telephone 402 having an integrated incentive promotions manager 3002. The integrated incentive promotion manager 3002 may be integrated within the operating software of the IP video telephone 402. The IP video telephone 402 would receive transmissions from a content provider 2404 or the host server 2410 asking the user of the IP video telephones to provide certain inputs such as scanning information into the IP video telephone 402 using the associated scanner 2406 or manually entering information into the IP video telephone 402 through the user interface. Responsive to these inputs to the requests provided by the host server 2410 or content provider 2404, the integrated incentive promotion manager 3002 provides various incentives to the user, such as entering the user into a contest of a particular content provider 2404. This would involve the incentive promotions manager sending a particular code back to the content provider 2404 through the network 2402 responsive to the user providing the desired input. Additionally, the user of the IP video telephone 402 could be provided with some type of coupon that could be printed upon a printer 3004 of the IP video telephone 402. The coupon may be used for some type of discount for the purchase of items related to the incentive promotion to which the user responded. The coupon could be used in a normal brick and mortar store or, alternatively, could have a code thereon which may be entered by a user to obtain the discount in an electronic commerce transaction.

Referring now to FIG. 31, there is illustrated the process by which the incentive promotion manager 3002 may provide incentives to a user of an IP video telephone 402. The content provider 2404 or host server 2410 generates a request at step 3102 for input to the IP video telephone 402. The user of the IP video telephone 402 provides an input response at step 3104 to the request. Responsive to the user input, an incentive is provided by the incentive promotion manager 3002 at step 3106. The provided incentive may be reviewed by the user of the IP video telephone 402 and stored either within the IP video telephone 402 or at a location associated with the IP video telephone 402 within the host server 2410 at step 3108.

Referring now to FIG. 32 and FIG. 33, there is illustrated a system for providing advertising within an audio/visual message recording and playback. When an IP video telephone 402a initiates an audio/visual telecommunication session with IP video telephone 402b in cooperation with the host server 2410 through the IP network 2402, a call notification is played at the IP video telephone 402b. If the call is not answered at step 3302 at the IP video telephone 402b, the content provider 2404 is notified of the non-answer at step 3304. Responsive to the non-answer at the IP video telephone 402b, the content provider 2404 sends at step 3406 advertising content and a pre-recorded request for recording a message to the IP video telephone 402a. The advertising and message are played on the display 3202 of the IP video telephone 402a. A message responsive to the ad and recording is recorded by the IP video telephone 402a on a CCD camera 3204, and the recorded response is stored at step 3308 on the host server 2410 or other appropriate location.

Referring now to FIG. 34, there is provided an illustration of the recording 3400 played by the content provider 2404 on the display 3202 of the calling IP video telephone 402a responsive to a non-answer condition. A first portion 3402 of the recording 3400 includes the ad content provided by the content provider 2404. This ad content would be related to the services or business of the content provider 2404. The second portion 3404 of the recorded message 3400 comprises the recorded message notification 3404 which would provide an audio/visual request to leave a message. In an alternative embodiment the ad content may be placed after the recorded message notification.

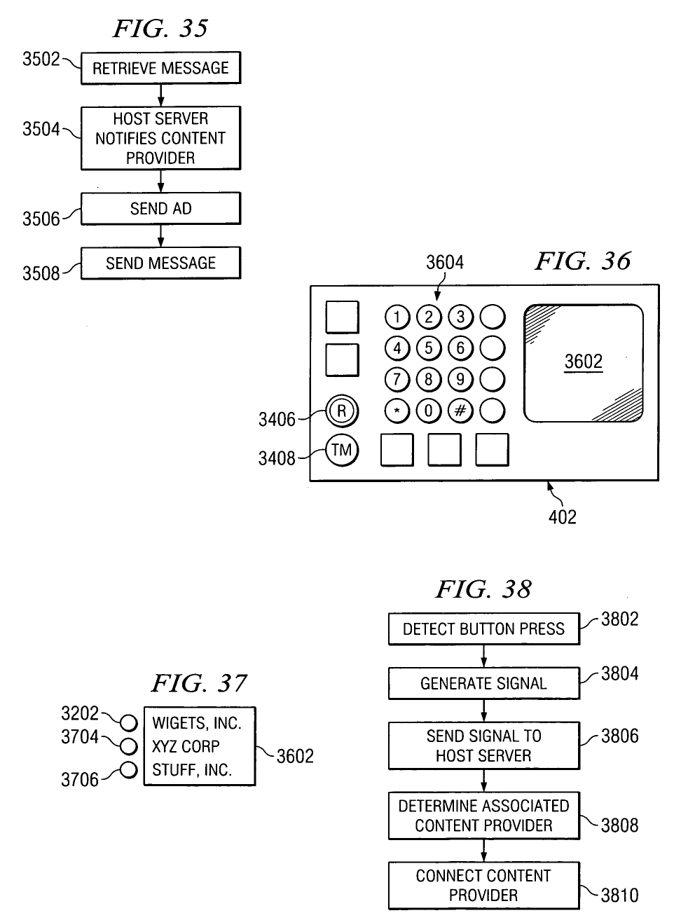

Referring now to FIG. 35, there is illustrated the manner in which an individual user of an IP video telephone 402b may retrieve messages that have been stored at the host server 2410 or other location. The user enters some type of code or indicator to retrieve stored message at step 3502. The host server 2410 notifies the content provider 2404 at step 3504 of receipt of the retrieved message request. The content provider 2404 sends an ad to the IP video telephone 402b at step 3506 responsive to this receipt notification. The recorded message is played for the user on IP video telephone 402b at step 3508. The sent message may come from the host server 2410 or whatever location that the recorded message has been stored for the user. As described previously, the ad content may also be played after the message.

Referring now to FIG. 36, there is illustrated one embodiment of the user interface of the IP video telephone 402. The user interface includes a display 3602 and a numeric keypad interface 3604. The user interface may additionally include a number of other buttons for providing other functions within the IP video telephone 402. Some of these buttons may be labeled with a symbol, trademark, trade name or other indicia associated with a particular content provider such as buttons 3406 and 3408. The user of the IP video telephone 402 automatically connects the IP video telephone 402 to the content provider 2404 via the network responsive to pressing of one of the iconic buttons 3406 or 3408. Information related to this content provider 2404 is then presented on the display 3602. The IP video telephone 402 may include any number of iconic labeled buttons 3406 and 3408.

In addition to the fixed mechanical buttons illustrated in FIG. 36, the IP video telephone 402 may have programmable buttons associated with user selected content providers 2404 wherein the content provider identifier would be displayed within a display area of the display 3602. In the example illustrated in FIG. 37, the display 3602 indicates three different content providers. These content providers include Widgets, Inc., XYZ Corp. and Stuff, Inc. Widgets, Inc. has a button 3702 associated therewith, XYZ Corp. has a button 3704 associated therewith, and Stuff, Inc. has a button 3706 associated therewith. Each of the content providers associated with these buttons may be programmed into the IP video telephone 402 such that by pressing the associated button 3702, the user would be connected directly to the content provider Widgets, Inc. A similar process would be associated with buttons 3704 and 3706. Programming of the button may be done through the browser controls or the numeric keypad interface 3604 of the IP video telephone 402.

Referring now to FIG. 38, there is provided a flow diagram illustrating the process for use of the iconic buttons for connecting to a selected content provider. Initially, at step 3802, the IP video telephone 402 detects a button press on the user interface of the phone 402. Responsive to detection of the button press, the IP video telephone 402 generates a signal requesting connection to the particular content provider associated with the button at step 3804. This may be done through the browser functionality in the video processor 422. The signal is sent at step 3806 to the host server 2410 to enable a connection to the content provider 2404. The host server 2410 determines the associated content provider 2404 at step 3808 and enables connection of the IP video telephone 402 to the content provider at step 3810.

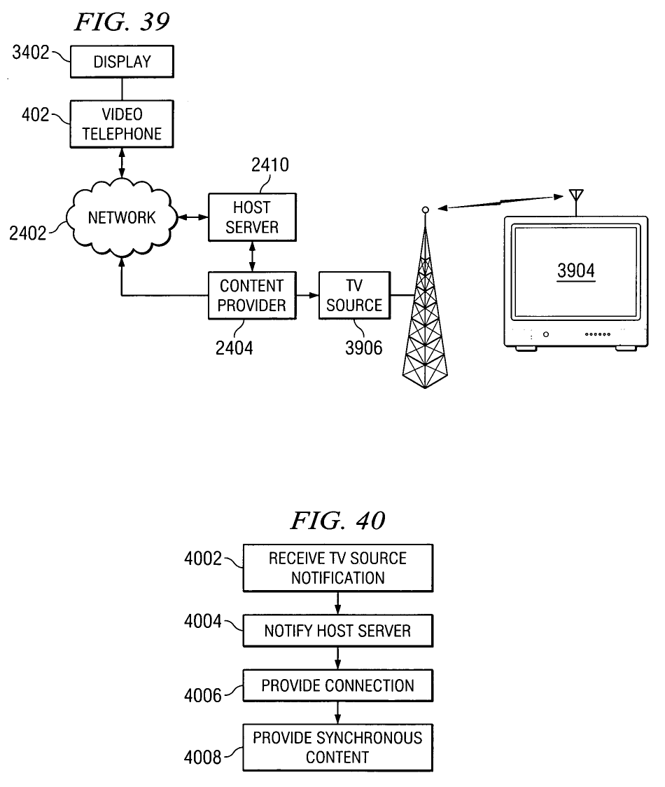

Referring now to FIG. 39, there is illustrated a system for providing a synchronous promotional content broadcast to an IP video telephone 402. An IP video telephone 402 having a display 3902 is connected to a network 2402 such as the Internet. A host server 2410 is communicably connected to the IP video telephone 402 via the network 2402. The host server 2410 is additionally connected with a content provider 2404. The content provider 2404 enables media content to be transmitted to a television 3904 by a T.V. source 3906 in communication with the content provider 2404 at the same time, or in some synchronous relationship with the broadcast of the same or related promotional content to the display 3402 of the IP video telephone 402. For example, a commercial may be broadcast from the T.V. source 3906 to the television 3904. When the commercial is finished playing on the television 3904, a related commercial may be played on the display 3402 of the IP video telephone 402 enabling the advertisers to reach a consumer through coordinated media content.

Referring now to FIG. 40, there is more fully illustrated the manner for the coordinated synchronous content. When the T.V. source 3906 transmits a commercial to a television set 3904, the T.V. source 3906 generates a notification that is received by the content provider 2404 at step 4002. Responsive to this notification from the T.V. source, the content provider 2404 notifies the host server at step 4004 of transmission of the T.V. content. The host server 2410 provides a connection between the content provider 2404 and the IP video telephone 402 at step 4006 to enable the content provider 2404 to provide the synchronous advertising on the display 3402 of the IP video telephone 402 at step 4008. In this way, an individual within the household associated with the video telephone 402 will substantially synchronously view the advertising content on the television set 3904 from the T.V. source 3906 and on the display 3402 of the IP video telephone 402 from the content provider 2404. The content provider 2404 may also initiate the transmissions or may cause the video phone ad to be played before the T.V. ad.

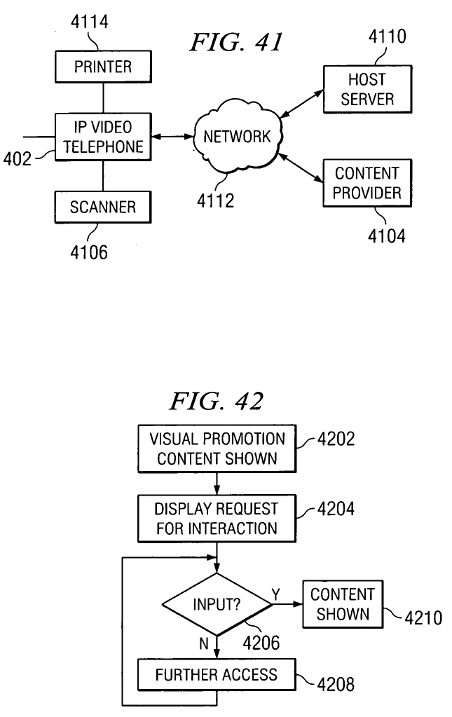

Referring now to FIG. 41, there is illustrated an IP video telephone 402 having an integrated incentive promotions function. The integrated incentive promotion function may be integrated within the operating software of the IP video telephone 402. The IP video telephone 402 would receive transmissions from a content provider 4104 or the host server 4110 asking the user of the IP video telephones to provide certain inputs such as scanning information into the IP video telephone 402 using the associated scanner 4106 or manually entering information into the IP video telephone 402 through the user interface. Responsive to these inputs to the requests provided by the host server 4110 or content provider 4104, the integrated incentive promotion function provides various incentives to the user, such as entering the user into a contest of a particular content provider 4104. This would involve the incentive promotions manager sending a particular code back to the content provider 4104 through the network 4112 responsive to the user providing the desired input. Additionally, the user of the IP video telephone 402 could be provided with some type of coupon that could be printed upon a printer 4114 of the IP video telephone 402. The coupon may be used for some type of discount for the purchase of items related to the incentive promotion to which the user responded. The coupon could be used in a normal brick and mortar store or, alternatively, could have a code thereon which may be entered by a user to obtain the discount in an electronic commerce transaction.

Referring now to FIG. 42, there is illustrated a flow chart of an integrated interactive promotion associated with the IP video telephone 402. When the IP video telephone 402 is functioning, visual promotional content is displayed on the display of the IP video telephone 402 at step 4202. The visual promotional content includes a request for interaction by a user of the IP video telephone 402 at step 4204. Inquiry step 4206 determines if some type of user input has been received. If not, control passes to step 4210 and additional content is displayed to the user. If inquiry step 4206 determines that user input has been received, control passes to step 4208 wherein the IP video telephone is given further access to promotional material by establishing a two-way audio/visual communication with a content provider 2404, displaying further media content or a mixture of these two processes. Responsive to these further accesses, inquiry step 4206 determines if additional input is received from a user and if not, normal content can again be shown at step 4210. The interactive process may continue between step 4208 and 4206 until all available content has been provided to the user or until the user is providing no more interactive input to the IP video telephone 402.

It will be appreciated by those skilled in The art having The benefit of this disclosure that this invention provides a broadband information appliance. It should be understood that The drawings and detailed description herein are to be regarded in an illustrative rather than a restrictive manner, and are not intended to limit The invention to The particular forms and examples disclosed. On The contrary, The invention includes any further modifications, changes, rearrangements, substitutions, alternatives, design choices, and embodiments apparent to those of ordinary skill in The art, without departing from The spirit and scope of this invention, as defined by The following claims. Thus, it is intended that The following claims be interpreted to embrace all such further modifications, changes, rearrangements, substitutions, alternatives, design choices, and embodiments.

1. A method of providing advertising to a video telephone, comprising:
monitoring usage of the video telephone to detect a number of user activities;
storing the user activities in a database;
generating directed content responsive to the user activities in the database; and
transmitting the directed content to the video telephone.

2. The method of claim 1, wherein the step of generating further the steps of:
selling the user activities to a content provider; and
generating the directed content at the content provider.

3. The method of claim 1, further including the step of scanning data into the video telephone to provide user activities.

4. The method of claim 1, further including the step of entering web site addresses into a browser associated with the video telephone to provide user activities.

5. The method of claim 1, further including the steps of:
providing interactive content to the video telephone; and
receiving a response to the interactive content to provide the user activities.

6. The method of claim 1, wherein the step of storing further comprises the step of storing the user activities in a file uniquely associated with the video telephone.

7. The method of claim 6, wherein the step of generating further comprises the step generating further comprises the step of generating unique content specifically for the video telephone from the user activities in the file.

8. The method of claim 1, wherein the step of generating further comprises the steps of:
analyzing the user activities to determine preferences of a user of the video telephone; and
generating the directed content according to the preferences of the user.

9. The method of claim 1, further comprising the steps of:
requesting a response to a promotion from the video telephone;
receiving the response from the video telephone; and
providing a reward responsive to receiving the response.

10. A method of providing advertising to a plurality of video telephones, comprising:
monitoring usage of the plurality of video telephones to detect a number of user activities;
storing the user activities associated with each of the plurality of video telephones in corresponding file of a database;
generating directed content for the plurality of video telephones, wherein the directed content for each of the plurality of video telephones is unique responsive to the user activities in the file of the database; and
transmitting the directed content to the plurality of video telephones.

11. The method of claim 10, wherein the step of generating further the steps of:
selling the user activities to a content provider; and
generating the directed content at the content provider.

12. The method of claim 10, further including the step of scanning data into the plurality of video telephone to provide user activities.

13. The method of claim 10, further including the step of entering web site addresses into a browsers associated with the plurality of video telephone to provide user activities.

14. The method of claim 10, wherein the step of generating further comprises the step generating further comprises the step of generating unique content specifically for at least one of the plurality of video telephones from the user activities in the file associated with the at least one of the plurality of video telephones.

15. The method of claim 10, wherein the step of generating further comprises the steps of:
analyzing the user activities to determine preferences of a user each of the plurality of video telephones; and
generating the directed content according to the preferences of the user.

16. The method of claim 10, further comprising the steps of:
requesting a response to a promotion from at least some of the plurality of video telephones;
receiving the response from at least some of the plurality of video telephones; and
providing a reward responsive to receiving the responses.

17. The method of claim 10, further including the steps of:
providing interactive content to the plurality of video telephones; and
receiving responses to the interactive content to provide the user activities.
